(19) United States
(12) Patent Application Publication
(10) Pub. No.: US 2025/0385730 A1
(43) Pub. Date: Dec. 18, 2025

(54) DECENTRALIZED MESH NETWORKING FOR SPACE CLUSTERS

(71) Applicant: Lockheed Martin Corporation, Bethesda, MD (US)

(72) Inventors: Nathan Swavely Goudie, Douglassville, PA (US); Michael Robert Blithe, King of Prussia, PA (US); Nickolas Andrew Weingartner, Schwenksville, PA (US)

(21) Appl. No.: 19/234,721

(22) Filed: Jun. 11, 2025

Related U.S. Application Data
(60) Provisional application No. 63/659,902, filed on Jun. 14, 2024.

(51) Int. Cl. H04B 7/185; H04W 72/12

(52) U.S. Cl. CPC H04B 7/18519; H04B 7/18513; H04W 72/12

(57) ABSTRACT

Provided herein are various enhancements for establishing distributed orchestration of mesh networking across a constellation of satellites. In one example implementation, a method includes identifying a local connectivity schedule covering at least a time interval for a satellite relative to other satellites of a constellation of satellites. The method also includes producing a merged connectivity schedule by merging the local connectivity schedule with additional local connectivity schedules determined by other satellites of the constellation. Based at least on applying a selected routing algorithm to the merged connectivity schedule, the method includes generating a forwarding almanac covering at least the time interval for the satellite, and establishing at least a portion of the communication network during the time interval by at least configuring a router of the satellite in accordance with the forwarding almanac.

### RELATED APPLICATIONS

This application hereby claims the benefit and priority to U.S. Provisional Application No. 63/659,902, titled “ON-BOARD DECENTRALIZED MESH NETWORKING ACROSS ASSETS,” filed Jun. 14, 2024, which is hereby incorporated by reference in its entirety.

### TECHNICAL BACKGROUND

As satellite constellations increase in popularity and size, the complexity of communications between space assets (e.g., satellites, ground stations, and other spacecraft) becomes increasingly difficult, especially in low-Earth orbits which have satellites passing over the horizon from each other and ground stations. To execute missions while in orbit, each satellite may manage one-to-many communication crosslinks to other satellites and vehicles while adjusting for factors, such as orbit, connectivity, ground communication, and other user communication that may affect the availability and timing for communications of a satellite.

In many existing solutions, satellites might only communicate with ground stations when the satellite has a direct line-of-sight to a ground station. In geostationary orbits, this is often not problematic, but in lower orbits closer to Earth, this may limit available communication windows for satellites. Satellite communication cross-linking was developed to overcome the need for orbital satellites to only communicate through ground stations. However, this cross-linking may occur only within a small coverage area if and when a pair of satellites are close together and have a line-of-sight to each other. Regardless of whether cross-linking is employed, control and management of routing, satellite cross-linking, and satellite-to-ground communications has been cumbersome and frequently employs a centralized node or human operator to attempt to optimize operations.

### SUMMARY

The description herein provides enhanced techniques and systems that provide for dynamic configuration of communication networks among space assets, such as space vehicles (SVs), satellites, and accompanying ground stations, or other various types of nodes and endpoints. A decentralized orchestration system is provided in which member satellites of a constellation can determine configurations of ad-hoc communication networks spanning over the satellites without a centralized planning and control node. Client-provided requests can be processed using satellite status information, such as windows of communication between nodes, to produce router configuration files usable to configure satellites in situ and establish various network routing over satellites with communication cross-linking for selected timeframes. Moreover, pluggable network routing and optimization algorithms can be customized and selected on-the-fly by users or network operators, and resultant router configuration files can provide router configurations for many different types of routers and associated software/hardware. In this manner, users can rapidly deploy and monitor satellite-based communication networks through interactive user interfaces.

In one example implementation, a method includes identifying a local connectivity schedule covering at least a time interval for a satellite relative to other satellites of a constellation of satellites. The method also includes producing a merged connectivity schedule by merging the local connectivity schedule with additional local connectivity schedules determined by other satellites of the constellation. Based at least on applying a selected routing algorithm to the merged connectivity schedule, the method includes generating a forwarding almanac covering at least the time interval for the satellite, and establishing at least a portion of the communication network during the time interval by at least configuring a router of the satellite in accordance with the forwarding almanac.

In another example implementation, a satellite includes an interface module comprising a router configured to receive mission parameters for a communication network among a constellation of satellites. The satellite also includes a mesh orchestration module configured to obtain the mission parameters, and based at least on the mission parameters, identify a local connectivity schedule covering at least the time interval for the satellite relative to other satellites of the constellation, and produce a merged connectivity schedule by merging the local connectivity schedule with additional local connectivity schedules determined by other satellites of the constellation. Based at least on applying a selected routing algorithm to the merged connectivity schedule, the mesh orchestration module can generate a forwarding almanac covering at least the time interval for the satellite, and establish at least a portion of the communication network during the time interval by at least configuring the router of the satellite in accordance with the forwarding almanac.

In yet another example implementation, an apparatus includes one or more computer-readable storage media, and program instructions stored on the one or more computer-readable storage media executable by a processing device. The program instructions can direct the processing device to at least obtain mission parameters for a communication network, based at least on the mission parameters, identify a local connectivity schedule covering at least a time interval for a satellite relative to other satellites of the constellation, and produce a merged connectivity schedule by merging the local connectivity schedule with additional local connectivity schedules determined by other satellites of the constellation. Based at least on applying a selected routing algorithm to the merged connectivity schedule, the program instructions can generate a forwarding almanac covering at least the time interval for the satellite, and establish at least a portion of the communication network during the time interval by at least configuring a router of the satellite in accordance with the forwarding almanac.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an exemplary operating environment demonstrating configuration of a communication network among satellites in a constellation.

FIG. 2 illustrates a method of establishing a communication network among satellites in a constellation in an implementation.

FIG. 3 illustrates exemplary elements used by an orchestration system to configure a communication network in an implementation.

FIG. 4 illustrates exemplary routing tables used to configure a communication network in an implementation.

FIG. 5 illustrates exemplary elements used by an orchestration system to configure a communication network in an implementation.

FIG. 6 illustrates an exemplary aspect of a user interface used in an implementation.

FIG. 7 illustrates an exemplary aspect of a user interface used in an implementation.

FIG. 8 illustrates exemplary aspects of a user interface used in an implementation.

FIG. 9 illustrates exemplary aspects of a user interface used in an implementation.

FIG. 10 illustrates techniques of establishing a communication network among satellites in a constellation in an implementation.

FIG. 11 illustrates an exemplary operating environment demonstrating configuration of a communication network among satellites in a constellation.

### DETAILED DESCRIPTION

Space vehicles (SVs) include any spacefaring vehicle or node, such as satellites, spacecraft, space probes, orbital craft, and other various craft. SVs, such as satellites, can be positioned in various orbital configurations about a central body, such as Earth, and arranged in various types of constellations. Each satellite can have on-board communication and data processing equipment, which may include hardware elements, such as antennas, transceivers, and networking devices (e.g., routers, relays, or switches), and software elements, such as software-defined network elements and associated routing and orchestration processing devices. This communication equipment and software may be configured to establish communication links between one or more other satellites to provide a communication network (or networks) that can be used to route traffic between endpoints. These endpoints may include ground-based nodes, or may instead include airborne, seaborne, orbital, or other various locations and types of endpoints.

An orchestration system can be provided on each SV which coordinates the communications, configuration, and operation of various communication systems of the constellation and individual SVs thereof. In some examples, ground-based command and control nodes can perform these orchestration functions, which then relay instructions and commands to the satellites for on-orbit configuration of the satellites. Once configured, the satellites can operate to route traffic among various endpoints, set up and tear down communication links, establish networks and network routing arrangements, and monitor network status and telemetry for delivery to the control nodes.

Discussed herein are enhanced orchestration elements and corresponding techniques for management of network resources among satellite systems. These examples provide for SVs with on-board orchestration and routing determination, instead of relying on centralized ground-based command and control. Thus, the examples herein describe decentralized command and control functions for already-deployed space nodes. Moreover, when hybrid constellations are deployed which have SVs capable of on-board orchestration along side SVs without such capability, the capable SVs can perform on-orbit orchestration for neighboring less capable SVs.

For satellite constellations, orchestration systems within each satellite can produce router configuration parameters to establish various customizable communication pathways and communication networks within the constellation. Clients, users, satellite vehicles, mesh orchestrators/controllers, mission controllers, or other control entities may provide mission parameters including requested operating parameters for the communication network, such as network endpoints, and targets for bandwidth, latency, and the like, along with a time interval for operation of the communication network. These control entities may also provide information about the satellites, such as capabilities of the satellites and equipment thereof (e.g., router capabilities), a number of the satellites, a current location of the satellites among the constellation, and the like. This information may also be provided by the orchestration elements based on monitored status of corresponding satellites. Based on the constellation information and requested operating and timing parameters of the communication network, the orchestration systems can identify satellites with which to establish the communication network and a routing path between the identified satellites, and distribute various routing information among nearest neighbor satellites. The orchestration systems can produce router-agnostic configuration files that can be translated into vendor specific format files and uploaded/uplinked or used to configure settings of communication equipment onboard the satellites.

One example implementation includes a method for establishing a communication network among space assets, such as satellites or other SVs. The method includes obtaining mission parameters for a communication network for a time interval among a constellation of satellites. The method also includes identifying one or more connectivity graphs for the constellation based on a state of the constellation during at least the time interval and applying a selected routing algorithm against the one or more connectivity graphs to generate a communication route among the constellation during the time interval. The method further includes producing a set of parameters to configure routing of the communication route among the constellation to establish the communication network for the time interval.

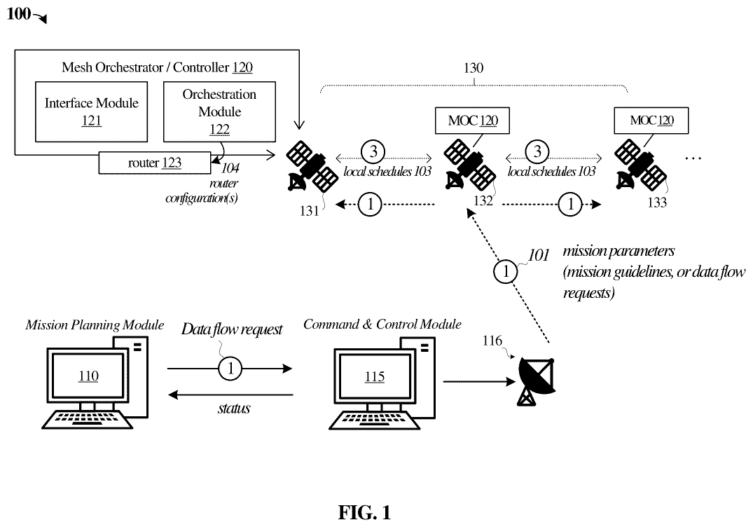

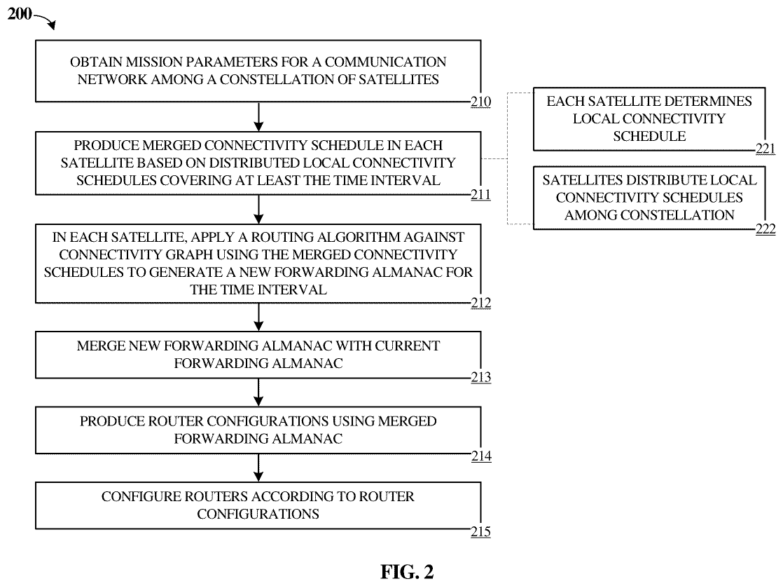

Turning now to the Figures, FIG. 1 illustrates an exemplary operating environment 100 demonstrating a configuration of a communication network among constellation satellites 130. Operating environment 100 includes various SVs, such as satellites 131-133 that each include a local instance of mesh orchestrator/controller 120 (MOC 120). Environment 100 also includes mission planning module 110, command and control module 115, and ground station 116. MOC 120 includes interface module 121 and orchestration module 122. In various examples, MOC 120 may be configured to perform communication network configuration processes, such as operations 200 of FIG. 2.

MOC 120 may be representative of a system or apparatus including various hardware, software, and/or firmware components, such as interface module 121 and orchestration module 122, capable of communicating with other MOC instances across different SVs or satellites, along with communicating with mission planning module 110 and command and control module 115 to receive inputs (e.g., mission parameters 101 and local connectivity schedules 103 from other satellites) and to provide outputs (e.g., local connectivity schedules 103). MOC 120 may communicate with mission planning module 110, command and control module 115, and other satellites using a communication protocol. For example, MOC 120 may communicate with each element using one or more application programming interfaces (API).

Mission planning module 110 may be representative of a computing device, such as a computer, tablet, smart phone, or other device, capable of configuring and viewing missions and activities of satellites 130 (e.g., a mission planning system) and determining when satellites 130 and ground station 116 can communicate based on orbits and positioning data. Mission planning module 110 may also, or instead, be representative of an application program that may be executed by a computing device. In various examples, mission planning module 110 may include a user interface through which a user can submit a data flow request that includes a set of requirements corresponding to a requested data flow through a communication network, and characteristics and performance thereof, between satellites 130 for a time interval. The set of requirements may include identities of preferred satellites in the constellation of satellites 130 to be included in the communication network (e.g., a starting satellite and an ending satellite to be included in the communication network), a bandwidth target, a latency target, a quality of service target, a selected routing algorithm, and a timeframe target that includes the time interval during which the data flow or communication network is to be established. Various other parameters, preferences, inputs, target metrics, and modes of operation can be specified.

Command and control module 115 may be representative of a computing device, such as a computer, tablet, smart phone, or other device capable of configuring parameters of satellites 130 or equipment thereof, controlling operations of satellites 130, and the like via ground station 116. Command and control module 115 may include a user interface through which a user can view constellation information, provide mission parameters and data flow requests to satellites 130, and optionally control aspects of satellites 130 via ground station 116. In some example embodiments, mission planning module 110 and command and control module 115 may be the same device. In other embodiments, mission planning module 110 and command and control module 115 may be different devices operating in the same or in a different environment.

Mission parameters 101 may include mission guidelines and data flow requests, and other information about satellites 130, such as a number of satellites 130 in a constellation, the types of satellites 130, capabilities of satellites 130 (e.g., types of equipment onboard satellites 130), transit nodes of the constellation (e.g., satellites, ground stations, other space assets), access nodes within the constellation (e.g., network, gateway, loopback from which data is received and to which data is sent by way of one or more transit nodes), data flows between satellites 130 and another communication network (e.g., logical connections between two access nodes that need to send data to each other), and the like. In some examples, MOC 120 may receive or otherwise obtain mission parameters 101 from mission planning module 110 or command and control module 115. In other examples, MOC 120 may receive, obtain, or access mission parameters 101 from a data structure of (or coupled to) MOC 120. In yet other examples, MOC 120 can determine real-time or upcoming status changes of members of a satellite constellation, which can prompt changes to local connectivity, and can adjust mission parameters 101.

Satellites 130 may include any number of satellites or other SVs in orbit around Earth (e.g., low-Earth orbit) or a terrestrial object, in cislunar orbit, or on a deep space trajectory, among other arrangements. Each of satellites 130 may include hardware, software, and/or firmware elements to communicate with each other and ground station 116, to capture data during orbit, and to control operations of elements onboard satellites 130, as well as perform mesh orchestration and control operations. In an example embodiment, satellites 130 each include routers and other networking equipment that can be configured in different ways at varying times to establish a communication network among a number of satellites 130 and ground station 116, among other ground stations (not shown). In another example embodiment, satellites 130 each include software-defined elements that can perform router and networking functions to establish a communication network among a number of satellites 130, which can optionally include ground station 116.

Also, although the term satellite is used herein, it should be understood that other vehicles can be employed, such as any space vehicles (SVs), spacecraft, space probes, satellites of various types and in various orbital configurations, and other spacefaring devices. Moreover, satellite devices can be included in sets or constellations which may be defined by orbital configuration groupings, or might be logical groupings of satellites, among other partitioning. Included in these sets may be other vehicles or devices which interface with satellites, such as aircraft, balloons, drones, unmanned aerial vehicles (UAVs), sea faring vessels, submarine vessels, terrestrial vehicles and stationary equipment (e.g., ground stations, facilities, installations), user equipment, computing devices, network equipment, and other various devices, vehicles, and equipment.

In operation, interface module 121 of MOC 120 may be configured to obtain mission parameters 101 from command and control module 115 or determine mission parameters 101 without communication with command and control module 115. When employed, command and control module 115 can base such mission parameters 101 on data flow requests originating from mission planning module 110. Interface module 121 can also share local connectivity schedules 103 with other satellites among the constellation. Interface module 121 can receive or otherwise obtain local connectivity schedules 103 from other satellites among the constellation. Orchestration module 122 may be configured to configure router 123 using routing configurations 104 determined based on the local connectivity schedules, the mission guidelines, and data flow parameters, among other factors. Orchestration module 122 can produce an almanac which may include a group of graph-based data, routing tables, and router configuration parameters for a particular time interval or time segment. As each satellite can include a local instance of MOC 120, these operations can be performed locally at each satellite for configuring router 123 of each satellite.

In various examples, to produce an almanac and/or router configuration, orchestration module 122 may identify a current state of satellites 130 based on local connectivity schedules 103. The current state may refer to positions and orientations of satellites 130 relative to one another and to earth or to specific terrestrial locations (such as ground station 116), which may be identified using telemetry data, ephemeris data, and/or calculated trajectories of each satellite. Orchestration module 122 may further identify a future state of satellites 130 by identifying scheduled maneuvers or movement of satellites 130 during a time interval, as indicated in local connectivity schedules 103 determined by each satellite and shared throughout the constellation mesh. The scheduled maneuvers or movements may indicate time-tagged connectivity changes to be made during the time interval, such as adding or removing a connection between a satellite and another space asset.

Next, orchestration module 122 identifies connectivity schedules for the constellation of satellites 130 for the time interval based on a state of the constellation. More specifically, orchestration module 122 can generate a connectivity schedule from the perspective of the local satellite for neighboring satellites implicated by mission parameters 101 during one or more time slices within the time interval. The connectivity schedules for each time slice may include a mapping indicating implicated satellites and communication lines-of-sight from a satellite to one or more other satellites or terrestrial locations, which may include reachability metrics corresponding to a physical distance or communication distance between each satellite or communication nodes thereof, a duration for which a given pair of satellites can communicate with each other (i.e., contact between satellites), a projected quality of communication between a given pair of satellites, a projected signal strength of the communication between a given pair of satellites, and the like, during the time slice. The connectivity schedules may include a table, chart, or graph representation with edges, vertices, and indications illustrative of a satellite, neighboring satellites, and respective positions thereof.

Orchestration module 122 can utilize information from each connectivity schedule during the time interval to create a reachability matrix that may include the reachability metrics and mappings from the perspective of each satellite. The reachability matrix might include all satellites of a constellation or a subset of satellites, may span over many constellations, and can indicate a validity timeframe for each communication during the entire time interval. In some examples, the reachability matrix may include a graph including edges, vertices, and data corresponding to the implicated satellites and communication parameters between the satellites. In other examples, the reachability matrix may include one or more tables or other data structures or mathematical formats.

Orchestration module 122 can then apply a selected routing algorithm against the connectivity graph. The routing algorithm can be selected using various techniques, such as being specified in mission parameters 101, or selected from among a set of predefined algorithms provided by orchestration module 122. In this manner, a user might select from among several provided algorithms, which may be provided/selected on-the-fly, or selected according to functional descriptions or mission requirements. Example routing algorithms include one or more among a lowest latency routing algorithm, a highest bandwidth routing algorithm, a shortest distance routing algorithm, a hop minimization algorithm, a Dijkstra's routing algorithm, or a mission specific routing algorithm, among others. The routing algorithm can be selected or provided as a plug-in algorithm to optimize, minimize, or maximize certain parameters, such as latency, distance, availability timeframe, bandwidth, or other factors. Based on the selected routing algorithm, orchestration module 122 can identify edge weights, factors, or costs for each communication path identified in the connectivity graph or connectivity matrix and determine routes among neighboring ones of satellites 130 to establish the communication network which satisfies the requirements of at least mission parameters 101.

Orchestration module 122 can generate a set of routing tables for at least a local router 123 based on the results of applying the routing algorithm to the connectivity graph. The routing tables may include a data flow table, a primary label registry, a forwarding information base (FIB) table, a label forwarding information base (LFIB) table, and an Internet-Protocol (IP) forwarding table, among other information. Orchestration module 122 may include this information in multiple formats such that the information can be applied to any target router, such as router 123, to establish routing for the communication network among satellites 130.

Thus, in some examples, one or more universal routing tables are determined, which may include parameters, addresses, and other parameters for configuring the communication network across many different types of routing equipment employing different manufacturers, brands, versions, protocols, interface control schemes, and the like. Orchestration module 122 can then export the routing tables as a configuration file, or almanac. In some examples, orchestration module 122 may further convert the universal routing tables into router-specific formatted files, which can be uploaded/uplinked and applied to routers onboard the satellites. Orchestration module 122 can utilize different plugins for different router types, and thus, may use several formats for router configuration, such as Yet Another Next Generation (YANG), Extensible Markup Language (XML), JavaScript Object Notation (JSON), or any other string-based file format. Using router configuration, a satellite can establish the communication network among implicated neighboring satellites to allow the satellites to send communications and data between each other and ground station 116 during the time interval and with parameters specified for a requested data flow. In some examples, orchestration module 122 deploys such configurations using NETCONF.

Mission planning module 110 may present, through a user interface of mission planning module 110, status and mapping of satellites 130 and the operations of the communication network. A user may interact to view specific hop points and pathways within the communication network, along with corresponding properties (e.g., bandwidth and latency targets) between nodes of the communication network, and timeframes that specific nodes may be in communication with one another.

Advantageously, a mesh network among satellites 130 can be dynamically generated during live-flight operations of satellites 130 to allow for one-to-one or one-to-many cross-linked satellites for the transfer of data and communications across a constellation of satellites in orbit around Earth. This process may allow a ground station to receive data outside of a timeframe or line-of-sight that it would not ordinarily be able to receive. In various examples, MOC instances of each satellite can apply such techniques to accommodate for several orbit types, different connections between various nodes among a constellation and on Earth, and with varying parameters via application of multiple different routing algorithms to generate time-tagged routing tables. Many of the aforementioned networks can be established over one or more constellations in a concurrent or partially overlapping timeframe, such that communications of more than one dynamically-configured network co-exist over at least some shared satellites. Segregation of the traffic among the various networks can be established using various network segregation or segmentation techniques, with various virtual private networks or encryption techniques applied thereto.

FIG. 2 illustrates a method of establishing a communication network between satellites in a constellation in an implementation. FIG. 2 includes operations 200 noted parenthetically in the discussion below and which reference elements of FIG. 1. In an example, operations 200 may be performed by network orchestration systems of individual satellites in a distributed manner, such as the various MOCs 120 of FIG. 1. Operations 200 may be executed by hardware, software, firmware, or any combination or variation thereof. Also, operations 200 can be performed by any satellite 130, and in typical constellations, can be performed concurrently by all satellites involved in routing constellation traffic and forming network arrangements.

In operation 210, interface module 121 of MOC 120 obtains (210) mission parameters 101 transferred by mission planning module 110 or generated in situ at a satellite to generate a communication network for a time interval among a constellation of satellites 130. This communication network can be generated to support a particular data flow (i.e., data routes provided between specified endpoints) or multiple data flows. The data flows can be indicated in mission parameters 101, or can be generated locally by any satellite of the constellation. In some examples, a single satellite (such as satellite 132 pictured in FIG. 1) might have line-of-sight with ground station 116 to receive the mission parameters 101 (and constellation information 102), and this satellite can distribute to various line-of-sight neighboring satellites, which can further distribute among the constellation. In this manner, all affected satellites can receive mission parameters 101 for local processing without having line-of-sight communication with ground station 116, or in situations where the communication network performs distributed planning without reliable contact with a ground station.

In various examples, mission planning module 110 may include a user interface through which a user can submit data flow requests that include a set of requirements corresponding to a requested data flow or communication network, and characteristics and performance thereof, between satellites 130 for a time interval. The set of requirements may include geographic locations for network endpoints, identities/addressing for network endpoints, identities of preferred satellites in the constellation of satellites 130 to be included in the communication network (e.g., a starting satellite and an ending satellite to be included in the communication network), a bandwidth target, a latency target, a quality of service target, a selected routing algorithm, a type of traffic to be carried/transported, and a timeframe target that includes the time interval during which the communication network is to be established. Various other parameters, preferences, inputs, nodes and endpoints (including other types of devices), target metrics, and modes of operation can be specified.

Interface module 121 may receive or otherwise obtain mission parameters 101 from command and control module 115 or some data source and provide mission parameters 101 to orchestration module 122. Command and control module 115 may be representative of a computing device, such as a computer, tablet, smart phone, or other device capable of configuring parameters of satellites 130 or equipment thereof, controlling operations of satellites 130, and the like via ground station 116. Command and control module 115 may include a user interface through which a user can view constellation information, configure satellites 130, and control satellites 130 via ground station 116. Command and control module 115 can be omitted in some examples, such as where constellation handles all operations in situ in a distributed manner.

Mission parameters 101 may include constellation information about satellites 130, such as a number of satellites 130 in a constellation, the types of satellites 130, respective locations of satellites 130 within the constellation, capabilities of satellites 130 (e.g., types of equipment onboard satellites 130), transit nodes of the constellation (e.g., satellites, ground stations, other space assets), access nodes within the constellation (e.g., network, gateway, loopback from which data is received and to which data is sent by way of one or more transit nodes), data flows between satellites 130 and a communication network, and the like. In some examples, MOC 120 may receive or otherwise obtain mission parameters 101 from command and control module 115. In other examples, MOC 120 may receive, obtain, or access constellation information 102 from a data structure/source of (or coupled to) MOC 120.

Satellites 130 may include any number of space vehicles or satellites in orbit around Earth (e.g., low-Earth orbit), or in other regions of space including cislunar, lunar orbit, non-orbital trajectories, and orbit about other celestial bodies. Each of satellites 130 may include hardware, software, and/or firmware elements to communicate with each other and ground station 116, to capture data during orbit, and to control operations of elements onboard satellites 130. In an example embodiment, satellites 130 each include data processing systems, along with routers and other networking equipment that can be configured in different ways at varying times to establish a communication network among a number of satellites 130, including among ground stations or terrestrial objects/locations (not shown). In another example embodiment, satellites 130 each include software-defined elements that can perform router and networking functions to establish a communication network among a number of satellites 130.

Based at least in part on mission parameters 101, each among satellites 130 can begin to determine a routing configuration to implement a communication network that supports one or more data flows between endpoints. Among these operations, connectivity schedules are determined to represent temporal communication connectivity among the satellites, which can then be processed using one or more routing algorithms to determine routing configurations to implement a requested data flow. The connectivity schedules are applicable for a period of time, such as time slice, and may include a mapping indicating implicated satellites and communication lines-of-sight from a satellite to one or more other satellites or other terrestrial locations, which may include reachability metrics corresponding to a physical distance or communication distance between each satellite or communication nodes thereof, a duration for which a given pair of satellites can communicate with each other, a projected quality of communication between a given pair of satellites, a projected signal strength of the communication between a given pair of satellites, and the like, during the time slice. The connectivity schedules may include a table, chart, or graph with edges, vertices, and indications illustrative of a satellite, neighboring satellites, and respective positions thereof.

However, in the distributed route orchestration systems discussed herein, a central command and control node might not be available or capable of determining connectivity schedules and routing configurations for an entire constellation of satellites, or for a particular period of time. Advantageously, individual satellites can determine or distribute mission parameters 101 to establish local connectivity schedules which can then be merged after distribution to each satellite. Specifically, in operation 211, each satellite produces merged connectivity schedules based on distributed local connectivity schedules covering at least the time interval. First, each satellite can determine a local connectivity schedule (operation 221), and then the satellites can distribute (operation 222) the local connectivity schedules among the constellation to eventually provide each satellite with copies of all local connectivity schedules. These local connectivity schedules can be merged or combined into a merged connectivity schedule by each satellite.

The local connectivity schedules comprise local, near-term communication connectivity schedules for a satellite. Local refers to communication connectivity from the perspective of a satellite, such that neighbor satellites are identified during a specified timeframe. The schedule can include expected direct network connections and destinations for a satellite, which can change over time due to various factors including orbital/trajectory properties, ephemeris parameters, changing directional communication arrays, available communication power (transmit/receive) due to solar irradiance, line-of-sight among satellites, and other various factors. Once each satellite receives the other local connectivity schedules determined by each individual satellite, a merged connectivity schedule can be established. The merged connectivity schedules consolidate all the local schedules, and can be employed in an almanac request for orchestration module 122.

Distribution of local connectivity schedules include transferring locally-determined connectivity schedules to neighboring or line-of-sight satellites, and re-distributing received local connectivity schedules received from other satellites as well. Thus, each satellite can transfer all local connectivity schedules received from other satellites to all neighboring satellites. To reduce/prevent too much traffic during this distribution phase, each satellite can omit distribution of local connectivity schedules to neighboring satellites that determined such local schedules. Once each satellite has local connectivity schedules determined by each satellite, the distribution process can complete.

Accompanying the distribution of the local connectivity schedules among the satellites, heartbeat signaling can also be distributed to neighboring satellites from each satellite. This heartbeat signaling can indicate that corresponding satellites are active/alive and able to participate in any routing determination. When one or more satellites fail to provide heartbeat indications, these satellites can be omitted from connectivity graphs and resultant routing configurations, as well as having command and control nodes notified of such status.

Orchestration module 122 of each satellite can utilize information from the merged connectivity schedule for an applicable time interval to create a reachability matrix that may include the reachability metrics and mappings from the perspective of each satellite. The reachability matrix might include all satellites 130 of a constellation or a subset of satellites 130, may span over many constellations, and can indicate a validity timeframe for each communication route during the entire time interval. In some examples, the reachability matrix may include a connectivity graph including edges, vertices, and data corresponding to the implicated satellites and communication parameters between the satellites. In other examples, the reachability matrix may include one or more tables or other data structures or mathematical formats.

In operation 212, orchestration module 122 of each satellite applies a selected routing algorithm against the connectivity graph (or reachability matrix) determined based on the merged connectivity schedule for the constellation to generate a new forwarding almanac for the time interval of interest. The new forwarding almanac can comprise a set of communication routes or router configurations among the constellation during the time interval. Based on the selected routing algorithm, orchestration module 122 can identify edge weights, factors, or costs for each communication path identified in the connectivity graph or reachability matrix and determine a route among a number of satellites 130 to establish the communication network which satisfies the requirements of at least a requested data flow.

A routing algorithm can be selected using various techniques, such as being specified in mission parameters 101, or selected from among a set of predefined algorithms provided by orchestration module 122. In this manner, a user might select from among several provided algorithms, or may instead be provided/selected on-the-fly or according to functional descriptions or mission requirements. Example routing algorithms include one or more among a lowest latency routing algorithm, a highest bandwidth routing algorithm, a shortest distance routing algorithm, a hop minimization algorithm, a Dijkstra's routing algorithm, or a mission specific routing algorithm, among others. The routing algorithm can be selected to optimize, minimize, or maximize certain parameters, such as latency, distance, availability timeframe, bandwidth, or other factors.

Once the selected routing algorithm has successfully been applied to the merged connectivity schedule, in operation 213, the new forwarding almanac can be merged with any existing or current forwarding almanac. From here, in operation 214, orchestration module 122 employs the merged forwarding almanac to produce router configurations for one or more routers on the particular satellite.

Orchestration module 122 of each satellite can use the merged forwarding almanac to determine router configurations for routing equipment of satellites 130 to implement the requested communication networks. In one example, orchestration module 122 of each satellite can produce a set of parameters to configure forwarding operation of the local routers each satellites to establish the communication network for the time interval. In various examples, orchestration module 122 can generate one or more routing tables based on the results of applying the routing algorithm to a merged connectivity schedule or associated connectivity graph. The routing tables may include a data flow table, a primary label registry, a forwarding information base (FIB) table, an LFIB table, and an Internet-Protocol (IP) forwarding table, among other information.

Satellites 130 can establish the communication network among each other using router configuration to send communications and data between each other and optional ground stations during the time interval and with parameters specified in mission parameters 101. During the specified timeframe, the various routers on each satellite can be configured (operation 215) using the router configurations to effectuate the merged forwarding almanac and produce the network configuration to support one or more requested data flows. The router configurations, which reflect the parameters in the merged forwarding almanac, can be continually updated as routing/network changes arise for particular timeframes indicated in the merged forwarding almanac.

One satellite can be configured to determine routing configurations for other satellites, such as satellites without enough processing capability to perform the aforementioned operations. In an example, a satellite can distribute router configurations through a cross-link communication (e.g., satellite-to-satellite) to one or more other satellites. Orchestration module 122 of a satellite may generate a universal routing table using the data flows and registry information to include this information in multiple formats such that the information can be applied to any router (e.g., via translation into a router-specific configuration file) to configure the route for the communication network among satellites 130. Thus, in some examples, the universal routing table may include parameters, addresses, and other parameters for configuring the communication network across many different types of routing equipment employing different manufacturers, brands, versions, protocols, interface control schemes, and the like. Orchestration module 122 can then export the universal route table as a configuration file (e.g., almanac) with the set of parameters for configuring the communication network to mission planning module 110, command and control module 115, and/or storage, including route tables having applicable time frames for validity.

Orchestration module 122 of each satellite can also transfer the merged forwarding almanac for delivery to mission planning module 110, or other command and control systems. Mission planning module 110 may present the merged forwarding almanac(s) through the user interface of mission planning module 110 to allow a user to view a status and mapping of satellites 130 and the communication network. A user may interact with a user interface to graphically view a representation of an almanac to view specific hop points and pathways within the communication network, along with corresponding properties (e.g., bandwidth and latency targets) between nodes of the communication network, and timeframes that specific nodes may be in communication with one another.

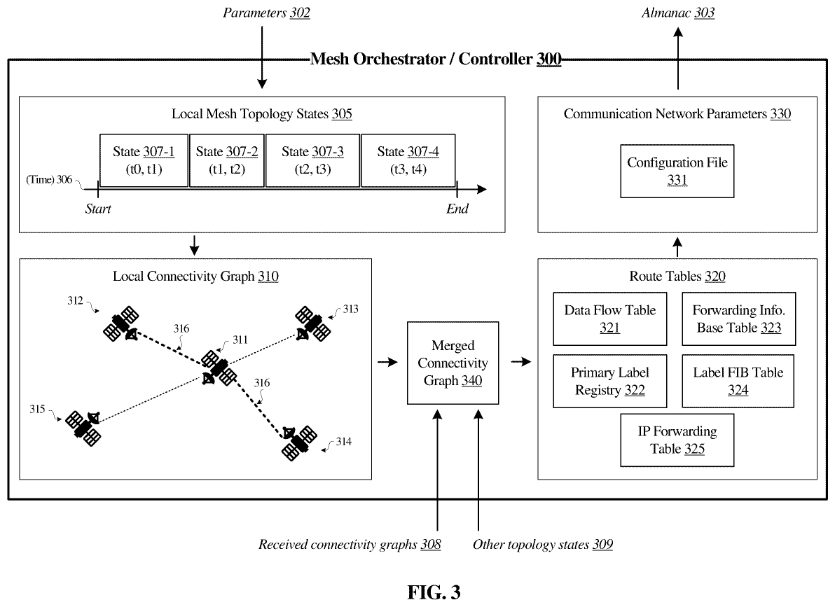

FIG. 3 illustrates exemplary elements to configure a communication network in an implementation. FIG. 3 includes mesh orchestrator/controller 300. MOC 300 can be one example implementation of MOC 120 on a satellite of FIG. 1, which can be included in the context of a constellation of satellites. In operation, MOC 300 receives request 300 as an input and produces an almanac or router configuration as an output (303). MOC 300 includes mesh topology states 305, connectivity graph 310, route tables 320 (as well as possible additional routing tables), and communication network parameters 330 to produce an almanac.

MOC 300 may be representative of a system or apparatus including various hardware, software, firmware components, docker components, deployed software payloads, containers, or other elements capable of processing network formation requests, communicating with terrestrial systems or devices (e.g., mission planning module 110, command and control module 115 of FIG. 1), and exchanging status/heartbeat signaling as well as local connectivity schedules with one or more satellites among a constellation, or with other space vehicles.

Parameters 302 may include a set of requirements corresponding to a requested data flow, communication network, characteristics, a time frame, or target performance related to satellites in a constellation. The set of requirements may include identities of preferred satellites in the constellation to be included in the communication network (e.g., a starting satellite/node and an ending satellite/node to be included in the communication network), a bandwidth target, a latency target, a quality of service target, a selected routing algorithm, traffic type/description, and a timeframe target that includes the time interval during which the communication network is to be established. Various other parameters, preferences, inputs, target metrics, and modes of operation can be specified.

MOC 300 may use parameters 302 along with other information about the satellites, such as a number of satellites in the constellation, the types of satellites in the constellation, respective locations of identified satellites within the constellation, capabilities of the satellites, and the like (e.g., constellation information), to generate local mesh topology states 305. Local mesh topology states 305 can comprise a schedule that includes state information about each neighboring satellite implicated by parameters 302 with respect to time 306. The state information may refer to positions and orientations of one or more of the neighboring satellites relative to a satellite executing MOC 300 (e.g., satellite 311) and optionally to Earth or to specific terrestrial locations (such as ground stations), which may be identified using telemetry data, ephemeris data, and/or calculated trajectories of each satellite. The state information may further include future positions and orientations of the one or more satellites based on scheduled maneuvers of the satellites. In an example, local mesh topology states 305 includes states 307-1, 307-2, 307-3, and 307-4 (collectively referred to as states 307) relative to time 306. State 307-1 may include state information about the implicated satellites between the first time (t0) and a second time (t1). State 307-2 may include state information about the implicated satellites between the second time (t1) and a third time (t2). State 307-3 may include state information about the implicated satellites between the third time (t2) and a fourth time (t3). State 307-4 may include state information about the implicated satellites between the fourth time (t3) and a fifth time (t4). It follows that during an orbit, the positions and orientations of the satellites may change over time for certain durations.

MOC 300 identifies connectivity schedules, such as local connectivity graph 310, for the satellites implicated by parameters 302 based on a local state or local schedule of a corresponding satellite during the identified time interval. Connectivity graph 310 may include a number of individual connectivity graphs, each connectivity graph from the perspective of satellite 311 at a different time slice (e.g., state 307-1, state 307-2, state 307-3, state 307-4) and including each satellite implicated by request 302. Each local connectivity graph may include a mapping of the satellites and communication lines-of-sight from satellite 311 to one or more other satellites, which may include reachability metrics corresponding to a physical distance or communication distance between each satellite or communication nodes thereof, a duration for which given pair of satellites can communication with each other, a projected quality of communication between a given pair of satellites, a projected signal strength of the communication between a given pair of satellites, and the like, during the time interval. Local connectivity graph 310 illustrates an example connectivity graph when the constellation is in state 307-1 during a first time slice between a first time (t0) and a second time (t1) within the time interval. While not shown, additional connectivity graphs may be determined at states 307-2, 307-3, and 307-4 of the constellation and include the same or different satellites in various positions and orientations based on planned maneuvers of the satellites during the time interval.

As illustrated, local connectivity graph 310 shows satellites 312-315, at respective positions and with respective orientations relative to satellite 311 according to one of states 307 of mesh topology states 305, such as state 307-1. The mapping of local connectivity graph 310 may correspond to a local state of mesh topology states 305 during time 306 that aligns with a time during the time interval indicated in parameters 302 (e.g., between t0 and t1). During this state, satellite 311 may be able to communicate with satellites 312-315, but not with other satellites of a constellation (not shown). Accordingly, for parameters 302 that indicates a request to establish a data flow or communication network between satellites 312 and 314, MOC 300 may determine that satellites 312 and 314 may not be able to communicate directly with each other and identify a communication route though satellite 311 to establish the requested data flow or communication network during this first time slice.

In addition to local connectivity graph 310, MOC 300 can receive other connectivity graphs 308 and other topology states 309. Other connectivity graphs 308 comprise local connectivity graphs transferred by other satellites or SVs, which are determined locally by those other satellites or distributed by those other satellites from yet further satellites. Other topology states 309 can be information related to the constellation related to node status, high-level topology state, or other information provided by a central node or with a mission request. For example, other topology states 309 might include scheduled node outages, node attrition, or node additions with corresponding timeframes. MOC 300 merges local connectivity graph 310 with the received connectivity graphs 308 and other topology states 309 to determine merged connectivity graph 340 which is provided to further route processing operational elements.

MOC 300 can apply a selected routing algorithm against merged connectivity graph 340, among other connectivity graphs, for the constellation. The routing algorithm can be selected using various techniques, such as being specified in parameters 302 (i.e., by specifying a pre-defined algorithm and including a set of metadata for use in the algorithm), or selected from among a set of predefined algorithms. In this manner, a user might select from among several provided algorithms, or may instead be provided/selected on-the-fly or according to functional descriptions or mission requirements. Example routing algorithms may include one or more among a lowest latency routing algorithm, a highest bandwidth routing algorithm, a shortest distance routing algorithm, a hop minimization algorithm, a Dijkstra's routing algorithm, or a mission specific routing algorithm, among others. The routing algorithm can be selected to optimize, minimize, or maximize certain parameters, such as latency, distance, availability timeframe, bandwidth, or other factors.

Based on the selected routing algorithm, MOC 300 can identify edge weights, factors, or costs (e.g., reachability metrics), for each communication path identified in the connectivity graph and determine a route among a number of the satellites to establish the communication network which satisfies the requirements of at least parameters 302. For example, MOC 300 may identify reachability metrics related to a duration for which a given pair of satellites can communicate with each other, a projected quality of communication between neighboring satellites, a projected signal strength of the communication between neighboring satellites, and the like, during the time interval. In this example, MOC 300 may determine that communication route 316, which includes communications between satellites 312 and 314 though satellite 311, is an available communication route for the time interval which satisfies the requirements of parameters 302.

Based on merged connectivity graph 340, MOC 300 can produce route tables 320 with configuration information corresponding to selected communication route 316 among satellites 311, 312, and 314. Route tables 320 may include data flow table 321, primary label registry 322, forwarding information base (FIB) table 323, label forwarding information base (LFIB) table 324, and Internet-Protocol (IP) forwarding table 325. MOC 300 may generate a universal routing table using this information in multiple formats such that the information can be applied to any router to configure the route for the communication network among satellites 311, 312, and 314. Thus, in some examples, the universal routing table may include parameters, addresses, and other parameters for configuring the communication network across many different types of routing equipment employing different manufacturers, brands, versions, protocols, interface control schemes, and the like. MOC 300 can then generate communication network parameters 330 from route tables 320 for configuring the communication network. Communication network parameters 330 may include configuration file 331 that includes router parameters in different languages to allow for the programming of any type of router onboard satellite 311 to establish the communication network during the time interval. In further examples, the router parameters can be established to configure a router other than found on satellite 311, such as for a neighboring satellite which lacks processing capability or local processing bandwidth to execute an instance of MOC 300.

MOC 300 can output almanac, including mesh topology states 305, merged/local connectivity graph 310/340, route tables 320, and communication network parameters 330 to one or more systems or devices, such as mission planning module 110 and command and control module 115 of FIG. 1.

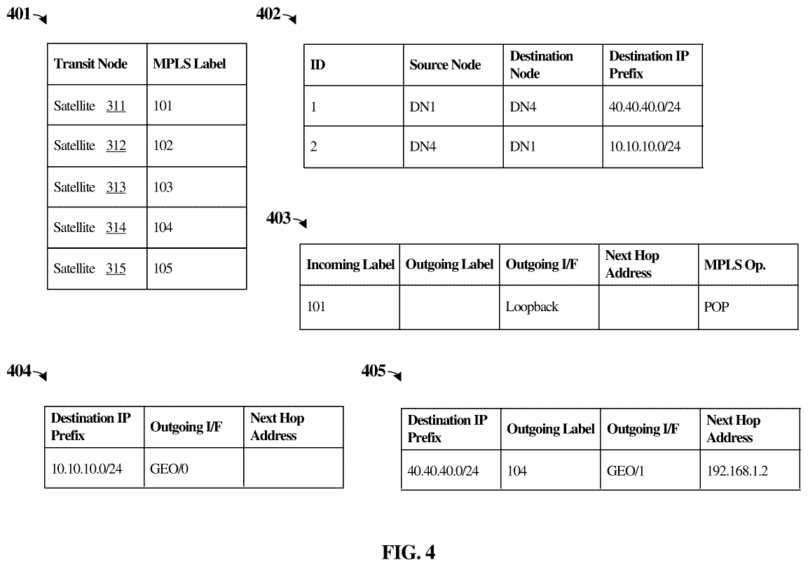

FIG. 4 illustrates exemplary routing tables used to configure a communication network in an implementation. FIG. 4 includes primary label registry table 401, data flow table 402, label forwarding information base (LFIB) table 403, Internet-Protocol (IP) forwarding table (IPFT) 404, and forwarding information base (FIB) 405, which can refer to similar elements of FIG. 3. In various examples, primary label registry table 401, data flow table 402, LFIB table 403, IP forwarding table 404, and FIB 405 may be included in a universal route table (e.g., route table 320 of FIG. 3) by an orchestration system (e.g., MOC 120 of FIG. 1 or MOC 300 of FIG. 3) during communication network configuration processes.

Primary label registry table 401 includes a table listing each satellite in a constellation, such as satellites 311, 312, 313, 314, and 315 of FIG. 3, and a respective multiprotocol label switching (MPLS) (packet forwarding technology using numeral labels to make fast forwarding decisions) reference label for each satellite. In this example, satellite 311 may be associated with MPLS label 101, satellite 312 may be associated with MPLS label 102, satellite 313 may be associated with MPLS label 103, satellite 314 may be associated with MPLS label 104, and satellite 315 may be associated with MPLS label 105. In some examples, some nodes or satellites may not include an MPLS label and, thus, may support IP only.

Data flow table 402 includes a table listing identifiers, source nodes, destination nodes, and destination IP prefixes based on communication network parameters identified by applying a routing algorithm to a connectivity graph. Data flow table 402 includes a first identifier with a source node of “DN1”, a destination node of “DN4”, and a destination IP prefix of “40.40.40.0/24”.

LFIB table 403 includes a table listing MPLS information associated with the first node in a communication network, such as an incoming label, an outgoing label, an outgoing interface, a next hop address, and an MPLS operation. LFIB table 403 may be used by a label switch router (LSR) (e.g., a router that handles labeled packets that arrive and swaps labels on the packet) to lookup where to route data. In this example, satellite 311 is the local node in the communication network, so “101” is listed as the incoming label corresponding to primary label registry table 401. The outgoing interface for satellite 311 may be listed as “loopback”, and the MPLS operation may be listed as “POP.”

IP forwarding table 404 includes a table listing IP information associated with the communication network, such as a destination IP prefix, an outgoing interface, and a next hop address. In this example, the destination IP prefix is “10.10.10.0/24” and the outgoing interface is “GEO/0.”

FIB table 405 includes a table listing MPLS information associated with the last node in the communication network, such a destination IP prefix, an outgoing label, an outgoing interface, and a next hop address. FIB table 405 may be a table used by a label edge router (LER) that handles unlabeled packets that arrive and pushes an MPLS label onto the packet. In this example, satellite 314 is the next node in the communication network, so “104” is listed as the outgoing label corresponding to primary label registry table 401. The destination IP prefix may be listed as “40.40.40.0/24”, the outgoing interface may be listed as “GEO/1”, and the next hop address may be listed as “192.168.1.2”.

In other examples, a routing table may include additional or fewer tables and different information based on the requirements for establishing a communication network, capabilities of satellites in the constellation, and the like. Further, a universal routing table may be determined using various routing tables, which may include parameters, addresses, and other parameters for configuring the communication network across many different types of routing equipment employing different manufacturers, brands, versions, protocols, interface control schemes, and the like following translation of the universal routing table into a router-specific configuration file. For example, the universal routing table may include data for any router format adaptable for a given mission, including MPLS and IPV4 or IPv6, among other formats. While MPLS is discussed above, the examples are not limited to MPLS, and instead other alternatives can be employed. These include Delay-Tolerant Networking (DTN) schemes, Software-Defined Wide Area Network (SD-WAN) arrangements, or Border Gateway Protocol (BGP) compliant routing tables and schemes.

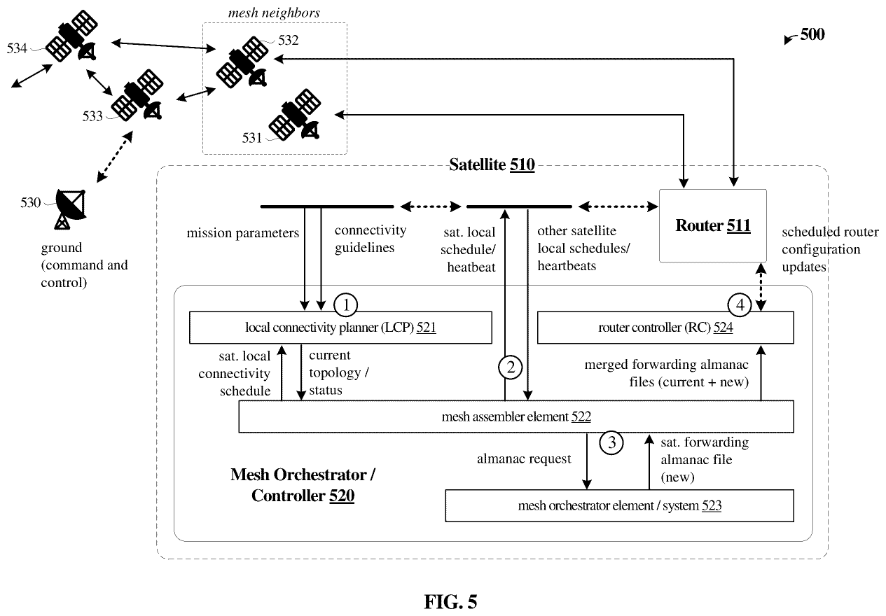

FIG. 5 illustrates exemplary elements used by an orchestration system to configure a communication network in an implementation. In FIG. 5, system 500 includes a constellation or set of satellites 510, and 531-534, along with ground node 530 which can optionally perform various command and control operations. Each satellite can include an instance of mesh orchestrator controller (MOC) 520, which is shown in detail for satellite 510.

Satellite 510 includes MOC 520 and router 511. MOC 520 includes local connectivity planner (LOC) 521, mesh assembler element (MA) 522, mesh orchestrator element (MO) 523, and router controller (RC) 524. Although not shown for clarity in FIG. 5, each of these elements can have various communication interconnect, software interfaces, APIs, or other features to provide intercommunication among the elements of MOC 520, as well as with router 511.

In operation, system 500 can provide a custom, ad-hoc, or on-the-fly network configuration which can vary over time based on satellite positioning, orbital changes, various types of reachability, line-of-sight, and other factors. Also, an entity which requests a network be formed can further specify properties of the network configuration provided by system 500, such as endpoints to connect using the satellite constellation, data flows, bandwidth requirements, traffic type descriptions, timeframes, and other requirements. Based on these various factors and requirements, each satellite of the constellation can determine routing configurations that implement the requested data flow, network configuration, and network requirements. As such, system 500 can provide for decentralized handling of satellite or space-based networks. Moreover, the techniques employed for space-based network configuration can be applied to any network, terrestrial, airborne, or combinations thereof.

Satellites 510, and 531-534 can each comprise a mesh node within a communication network, and each of these mesh nodes includes local route processing/planning equipment and local router equipment. Each mesh node can regularly plan out short-term local connectivity schedules that are also distributed to each currently connected neighbor satellite. Neighbor satellites can refer to satellites with direct communication connectivity to another satellite without an intermediate ‘hop’ or other mesh node, forming direct point-to-point links. In an iterative manner, each mesh node relays (to neighbor nodes) both the locally-generated connectivity schedule and local connectivity schedules generated at other nodes. Each mesh node also regularly generates its own near-term forwarding almanac, which includes entries based upon all received local connectivity schedules and requested mission data flows. Each local controller (MOC 520) of a node dynamically executes the appropriate connectivity commands and router configuration changes at the specified times. New feasible neighbors are discovered and verified via beacon-signal-based handshake/negotiation interfaces. Local connectivity decisions can be made by a designated highest-ranking node involved in each potential connection, and can be based upon a set of mission-provided constraints, preferences, guidelines, and/or historical data.

Turning now to more detailed operations of MOC 520, Local Connectivity Planner (LCP) 521 obtains mission parameters (1), which can include mission planning data, data flow requests, and data flow parameters, among other data. From here, LCP can consider the latest mission data, both pre-planned and ad-hoc, and use this mission data to create a next local, near-term connectivity schedule for the local satellite. This schedule includes expected direct (point-to-point) network connections and destinations. The connectivity can be determined as noted herein, such as line-of-sight, proximity, latency, signal strength/connectivity, or other factors. Vehicle/node ephemeris can be employed to determine this connectivity for the local mesh node and other mesh nodes, along with information provided in the mission plans submitted in requests.

In this manner, LCP 521 periodically (and/or as needed) creates the next local network connectivity schedule. Each new schedule is derived from a combination of pre-planned connections for the local satellite along with any newly received mission connectivity guidelines and/or unexpected mesh topology status changes (such as determined and reported by MA 522). LCP 521 does not typically maintain an understanding of the overall constellation/mesh network topology. Instead, LCP 521 can capture a local connectivity schedule of upcoming direct connections for the local satellite, tracking identities of connected neighbor nodes and timeframes for connection to such nodes.

MA 522 accepts and distributes local connectivity schedules and sends heartbeat messaging (2) to each of the current neighbors of a local satellite. MA 522 also can receive and propagate local schedules and heartbeat messaging received from the other mesh nodes (satellites) currently in the same constellation/cluster. Periodic heartbeat messaging can be employed to check if currently scheduled neighbors are still connected, as well as for acknowledgement messaging from each propagated/transferred connectivity schedule. MA 522 can drive the propagation and exchange of local schedules and heartbeats within a cluster, as well as the generation, processing, and submission of each new local forwarding almanac files. This can be achieved by receiving a newest local connectivity schedule as provided by the local LCP 521 and sending the local connectivity schedule to each current neighbor, which might be defined as directly connected MA 522 instances of each mesh satellite/node assigned Multiprotocol Label Switching (MPLS) labels, destination IP addresses, and/or system ports. MA 522 can listen for and receive local schedules and heartbeats from all current neighbors (and iteratively, from next-hop current neighbors, etc.). In some examples, responsive to MA 522 receiving a new local connectivity schedule from another node (a local connectivity schedule that has not been received previously), then MA 522 can store that schedule and propagate/send the new local connectivity schedule to all neighboring nodes/satellites, except for the node that sent the new local connectivity schedule.

Also, after receiving a new locally-generated connectivity schedule from LCP 521, and prior to sending it to any neighbors, MA 522 can update a router configuration for router 511 to ensure the forwarding entries needed to communicate with each currently scheduled neighbor are also currently configured on router 511. MA 522 can communicate with router controller (RC) 524 to implement this updated configuration for router 511.

MA 522 also can assemble received/native local connectivity schedule information into a merged connectivity schedule(s) and include this merged connectivity schedule in a corresponding mesh almanac request (3) submitted to MO 523. MA 522 merges various local connectivity schedules into a merged connectivity schedule. The content of the connectivity schedules can vary upon implementation, but typically include indications of the connectivity, time intervals or time frames over which the connectivity applies, network addressing information for the connectivity, node identifiers associated with routing elements or space vehicle identities, and timestamps for heartbeat messaging, and other indications.

The various local connectivity schedules correspond to locally-determined connectivity schedules, as well as those received from other mesh nodes which determine their own locally-determined connectivity schedules. In this manner, each mesh node can determine its own local connectivity schedule, distribute this local connectivity schedule to other mesh nodes, and receive local connectivity schedule from the other mesh nodes-forming a distributed arrangement in which individual mesh nodes determine individual local connectivity schedules. Over time, all mesh nodes will have updated merged connectivity schedules based on receiving from neighbors and from internal local connectivity schedules. These local connectivity schedules can vary based on each mission plan and the ephemeris of the mesh nodes.

MO 523 can responsively generate a next local forwarding “almanac file” for the local satellite, based on applying various routing algorithms to the merged connectivity schedule. The next local forwarding almanac file can comprise timewise router configurations, with associated routing tables valid for particular timeframes. The routing tables include parameters for configuring a communication network provided by the satellites in FIG. 5. In some examples, MO 523 may generate universal routing tables applicable for any/many router types into router-specific formatted files, such as a router-specific configuration for router 511, which can be uploaded/uplinked and applied to router 511 by RC 524. MA 522 can retrieve this next local forwarding almanac file, which includes time-tagged router configuration changes. This almanac file might be in a YANG, XML, or JSON format, among other file formats. MA 522 then can merge the next local forwarding almanac file (as needed) with any old/active local forwarding almanac files, and then can commit/send the resulting “merged” local forwarding almanac file to RC 524.

However, to produce the next local forwarding almanac, an example set of operations can be employed. MO 523 can produce the next local forwarding almanac by executing one or more routing algorithms against the merged connectivity schedules received from MA 522. MO 523 can provide for the routing algorithms to be ‘plugins’—this enables MO 523 to modularly ‘switch out’ a routing algorithm with another on a case-by-case basis. For example, a mission could use a Dijkstra's shortest path algorithm, switch to a more resilient algorithm, or switch to more experimental algorithms provided by third-parties that define ‘optimal’ in different ways (i.e., Quality-of-Service, bandwidth, weather, or other factors). Example routing algorithms include one or more among a lowest latency routing algorithm, a highest bandwidth routing algorithm, a shortest distance routing algorithm, a hop minimization algorithm, a Dijkstra's routing algorithm, or a mission specific routing algorithm, among others. The routing algorithm can be selected to optimize, minimize, or maximize certain parameters, such as latency, distance, availability timeframe, bandwidth, or other factors. These algorithms can be integrated via a standards-based API and SDK, so third-parties (such as those initiating mission requests) can integrate selected algorithms and have them applied in the same fabric. These plugins can be used against both ground-based orchestrator systems as well as on-board orchestrator systems, such as in this example. This design and architecture allows for more fluid use and testing. For instance, an algorithm could be tested and perfected on the ground, then ported over to space vehicles at a low-cost without heavy refactoring.

As mentioned, MO 523 can apply a selected routing algorithm against the merged connectivity schedule for the constellation. Based on the selected routing algorithm, MO 523 can identify edge weights, factors, or costs for each communication path identified in the merged connectivity schedule and determine route(s) among a number of satellites/mesh nodes to establish the communication network which satisfies the requirements of at least the mission request.

MO 523 can generate a set of routing tables for each node based on the results of applying the routing algorithm to the merged connectivity schedule. The routing tables may include a data flow table, a primary label registry, a forwarding information base (FIB) table, a label forwarding information base (LFIB) table, and an Internet-Protocol (IP) forwarding table, among other information. MO 523 may include this information in a format suitable for router 511, or instead using multiple formats such that the information can be applied to other routers in the constellation to configure the route for the communication network among satellites. Thus, in some examples, one or more universal routing tables are determined, which may include parameters, addresses, and other parameters for configuring the communication network across many different types of routing equipment employing different manufacturers, brands, versions, protocols, interface control schemes, and the like.

RC 524 can maintain a representation of a current mesh topology, such as a connectivity graph, as determined by the heartbeats and schedules received (or not received) by each of the nodes/satellites currently scheduled neighbors. This connectivity graph can be retrieved by LCP 521 and factored into subsequent cycles of planning and determination of local connectivity schedules. RC 524 can apply (4) the merged forwarding almanac, which includes scheduled router configuration updates, to router 511 over the course of a time interval specified for the almanac. RC 524 can receives and process the merged forwarding almanac files, update configuration change schedules for router 511 to reflect the latest merged forwarding almanac data, and then dynamically apply these changes to router 511 router at the scheduled times. These router configuration changes for router 511 applied by RC 524 according to the merged forwarding almanac can thus dynamically form a mesh network among satellites/nodes, using locally-generated connectivity and processing instead of centralized or terrestrial command and control.

Many conventional examples might employ a centralized or ground-based controller node for network planning and router configuration determination/distribution to various satellites of a constellation. However, in the enhanced implementations discussed herein, a distributed or local almanac determination and distribution scheme is employed. As mesh-networked constellations grow in scale, the constellations become more reliant on centralized mechanisms to perform network planning. Even with resilient algorithms on-ground routing designs, a centralized architecture can introduce risk to the overall architecture and limits to the available mission operations available to explore.

Thus, an on-board version of an orchestration system, such as MOC 520, can alleviate resiliency concerns and move network planning to an autonomous layer that brings additional functionality and resilience to a constellation. In some examples, an on-satellite or on-vehicle (i.e., on-board) version of an orchestration system can move a constellation towards enhanced autonomy and resiliency by allowing each vehicle to plan its own network connections as needed. Moreover, requested data flows can be supported over a communication network or networks which are adjusted or altered as-needed as conditions change, positioning of network nodes change (e.g., satellite movement), or failures occur. All of this activity can be handled in situ by instances of MOC 520, instead of relying on centralized command and control systems.

In FIG. 5, an implementation of a decentralized architecture is shown, allowing a network to evolve organically. By doing this, nodes, such as space vehicles or satellites, can have the functionality to reach out to neighbors (as indicated by local connectivity determinations) and replan network connections as well as, over time, affect the overall network. This would allow a network to operate more autonomously such that an anomaly on a mesh node can trigger a decentralized system to recover itself, routing data around a problem without centralized control from a ground-based controller or orchestration system, for example.

This configuration has applications towards resiliency of the constellation (reconstituting the overall topology without signaling/control coming back to/from the ground) as well as real-time autonomy as needed. A network/mission request can initiate a planning operation that breaks out each period of stability, generate a graph for each segment, apply a route solving algorithm against it (which can be inserted by each mission and be mission specific against APIs/SDK (software developer kit)), transform it to a universal routing table format before finally transforming into the specific router format for that constellation (another mission specific insertion point). In one implementation, a version of the stateless orchestration system, as well as an additional assembler element, is combined with mission specific elements for ‘local’ connectivity and the on-board router/controller. Here, each mesh node plans and generates its own forwarding almanacs in concert with the other mesh nodes in the same cluster. Each mesh node then uses its almanacs to dynamically configure its own router over time.

To this end, constellations can utilize this functionality in a variety of ways—not limited to Emergency Resiliency, Operational Augmentation. In emergency resiliency scenarios, mesh nodes can execute mesh route determination on-board, which moves the decision making for networking from central control (ground) to the space-deployed vehicle. In this mode, it's possible to ‘crawl’ to autonomy by loading the application to vehicle(s) in the constellation, and use them in an emergency situation. It would be possible to utilize the orchestrator system on-board in this context to ‘turn on’ in case a detected emergency were to happen, allowing the constellation to begin to ‘heal’ without coming to the ground (or if the ground is compromised). In this vein, this can also be done under nominal conditions to test, but enables an additional layer of resiliency once in place that is not available currently.

In operational augmentation scenarios, once in place, a mesh assembler element can begin to situationally (or permanently) utilize autonomy in operations. Subsets of the constellation can be made autonomous regularly, only reaching back to ‘sync’ with the ground controller/centralized orchestrator system as needed. This can enable more autonomous actions. For example, when over certain geographic areas, a move to network planning can be triggered to be done in-node or decentralized, or triggered by other autonomous actions, such as if a tracking space vehicle triggers a network change, a node can start to remake a network.

In some scenarios, network planning can be moved entirely on-board to a mesh node/satellite. For instance, the constellation or individual mesh nodes can be configured so that they are running a mesh orchestrator system on-board (and using an on-ground version only as a backup). In this scenario, the ground can be turned into more of a ‘shepherd’—it would do planning and requests, but all networking could happen on-board instead of driven by the ground or centralized orchestrator system. In further examples, tasking could be done via multiple locations, allowing the network at the time to receive it, and then reconstitute the overall topology to meet mission needs at the time and get data down most efficiently. This would also protect against a centralized failure for a longer period of time.

Thus, according to the above descriptions and that of FIG. 5, techniques include obtaining a mission request to generate a communication network for a time interval among a constellation of satellites, and identifying one or more local connectivity schedules for satellites of the constellation based at least on a state of the satellites of the constellation during at least the time interval. The techniques also include producing merged connectivity schedules by at least merging a local connectivity schedule with one or more additional local connectivity schedules determined by one or more other satellites of the constellation. The techniques also include applying a selected routing algorithm against the merged connectivity schedules to generate a communication route for the satellite of the constellation the time interval, and applying the communication route in a router element to form a mesh network which varies over time in connectivity among nodes.

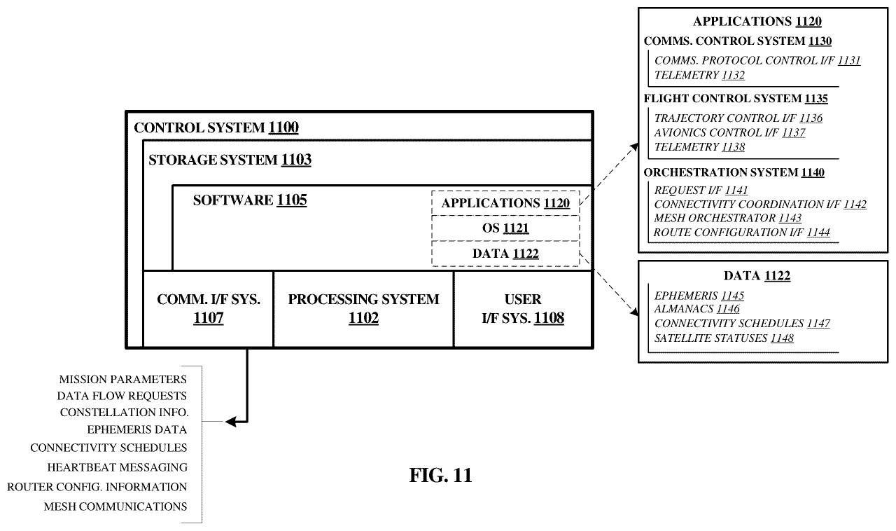

Returning to a discussion on the elements of FIG. 5, satellites 510 and 531-534 can comprise various components discussed below for FIG. 11, although variations are possible. Satellites 510 and 531-534 can implement one or more instances of MOC 520, which can be deployed as executable software payloads, containers, Docker elements, applications, operating systems, or other software components.

Satellites 510 and 531-534 can comprise mesh nodes, space vehicles, or other various node types. Satellites 510 and 531-534 can comprise various chassis, bus, or structural elements which might house power/propulsion elements, station keeping equipment, solar panels, communication elements and antennas, logistical elements, and various network orchestration and data processing elements. Examples of satellites 510 and 531-534 include central processing units (CPUs), various discrete and programmable logic devices, memory/storage devices, and communication equipment.

Communication equipment of satellites 510 and 531-534 can include network router equipment, as well as various physical and logical elements to implement direct communications with other nodes/satellites. This communication equipment can include transceivers, amplifiers, filters, controllers, antennas, optics, aiming elements, beamforming elements, and other components. Inter-satellite communication and ground communication can include radio frequency (RF) communications (including beamforming and antenna aiming equipment), optical communications (including optical aiming and focusing equipment), and other communication equipment.

Router 511 can include network routing hardware, various wired/wireless/optical interfaces for intra-satellite communication with elements executing MOC 520. Router 511 can implement various network stack processing components, including physical layer establishment, link layer control, transport layer handling, and other higher-level network stack layer processing/handling. Router 511 can be at least partially implemented as a software-based router and executed by elements which execute MOC 520. Router 511 can be at least partially implemented as a hardware router, with dedicated circuitry for handling network routing operations and control. Router 511 can include traffic buffers, packet handlers, packet inspection elements, routing processors, and various other elements.

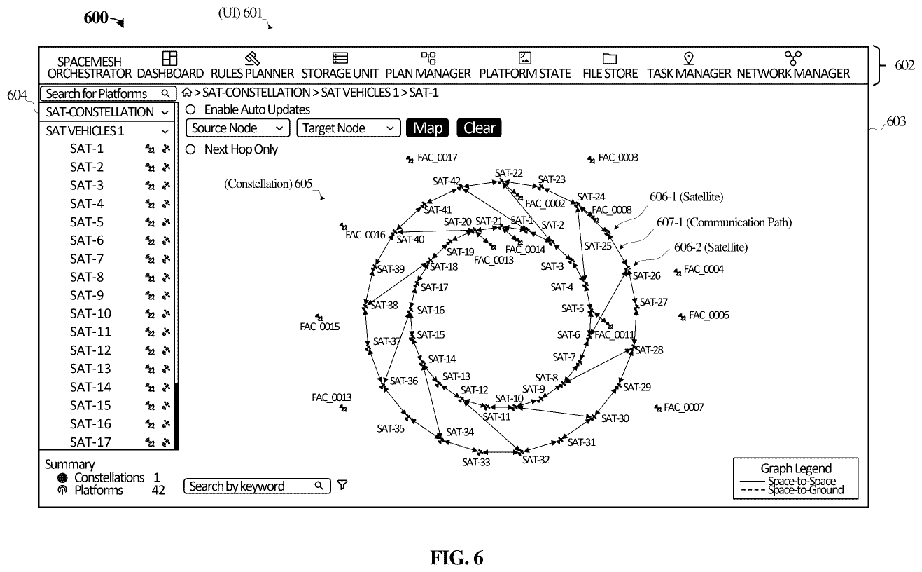

FIG. 6 illustrates an exemplary aspect of a user interface (UI) 601 used in an implementation. FIG. 6 includes UI 601, which includes function toolbar 602, display window 603, and asset list 604. In various examples, UI 601 may be presented in a computing device or system, such as mission planning module 110 or command and control module 115 of FIG. 1.

In use, UI 601 can provide a visual representation of assets in a system, such as satellites 606 in constellation 605, and functions of an application presented through UI 601. Function toolbar 602 may include one or more icons representative of functions or views that can be navigated through by interacting with UI 601 (e.g., touch, click, tap, swipe). For example, function toolbar 602 may include icons representative of a dashboard function, a rules planner function, a storage unit function, a plan manager function, a platform state function, a file store function, a task manager function, and a network manager function, among other functions and views. Upon interacting with an option of function toolbar 602, UI 601 may present a visual representation on display window 603.

In aspect 600, UI 601 shows an example visual representation of constellation 605 on display window 603. Constellation 605 may include a number of satellites 606 arranged in concentric rings, although other arrangements may be contemplated. Asset list 604 may include a list of satellites 606, among other space-deployed assets, space vehicles, ground stations, and the like. Each satellite of constellation 605 may communicate with one or more other neighboring satellites in constellation 605. The lines connecting each satellite in the visual representation shown in display window 603 may represent communication paths 607 between the satellites. For example, satellite 606-1 and satellite 606-2 may communicate with each other via communication path 607-1

In various examples, a user may click, tap, touch, or otherwise interact with each satellite of constellation 605 to view information about the satellite, zoom in or zoom out on display window 603 to view communication paths 607 between satellites 606, and toggle between different constellations, if available, among other functions. For instance, a user may click on satellite 606-1 to view a state of satellite 606-1. The state of a satellite may refer to an operation status, a current position, a current orientation, and scheduled maneuvers of the satellite, among other information.

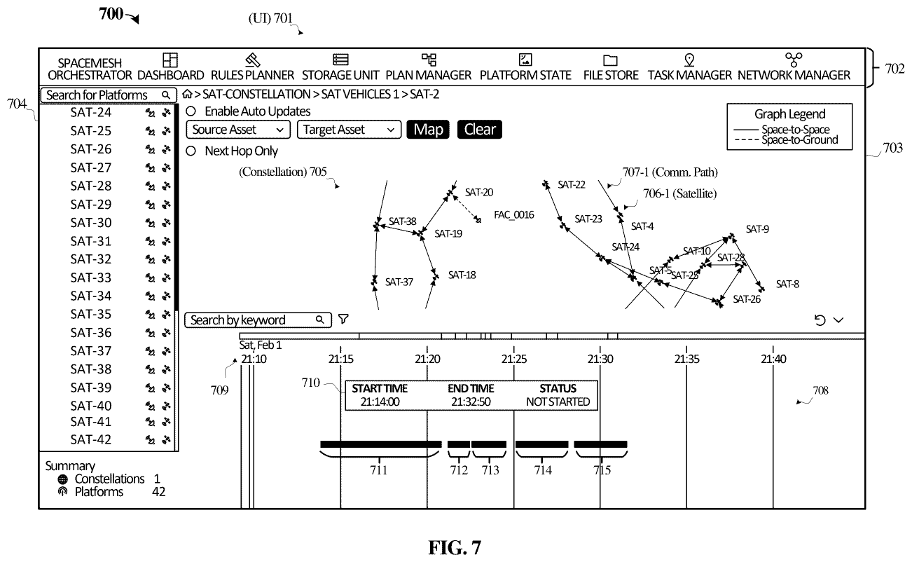

FIG. 7 illustrates an exemplary aspect of user interface (UI) 701 used in an implementation. FIG. 7 includes UI 701, which includes function toolbar 702, display window 703, asset list 704, and connectivity graph 708. In various examples, UI 701 may be presented in a computing device or system, such as mission planning module 110 or command and control module 115 of FIG. 1.

In use, UI 701 can provide a visual representation of assets in a system, such as satellites 706 in constellation 705, and functions of an application presented through UI 701. Function toolbar 702 may include one or more icons representative of different functions or views that can be navigated through by interacting with UI 701 (e.g., touch, click, tap, swipe). For example, function toolbar 702 may include icons representative of a dashboard function, a rules planner function, a storage unit function, a plan manager function, a platform state function, a file store function, a task manager function, and a network manager function, among other functions and views. Upon interacting with an option of function toolbar 702, UI 701 may present a visual representation on display window 703.

In aspect 700, UI 701 shows an example visual representation of constellation 705 on display window 703. Constellation 705 may include a number of satellites 706 arranged in orbit. However, display window 703 may show only a portion of satellites 706 as UI 701 may present a zoomed-in view of constellation 705 in aspect 700. Asset list 704 may include a list of satellites 706, among other space-deployed assets, ground stations, and the like. Each satellite of constellation 705 may communicate with one or more other neighboring satellites in constellation 705. The lines connecting each satellite in the visual representation shown in display window 703 may represent communication paths 707 between the satellites. For example, satellite 706-1 may communicate with another satellite via communication path 707-1.

UI 701 may include connectivity graph 708 in a portion of display window 703. Connectivity graph information 710 may also be displayed on display window 703 and include information about connectivity graph 708, such as a start time, end time, and status of communication network. Connectivity graph 708 may include a timewise view of states of constellation 705 with respect to time 709. The states of constellation 705 may refer to positions and orientations of satellites 706 relative to one another and to earth, the moon, or other terrestrial objects, or to specific terrestrial locations, such as ground stations, which may be identified using telemetry data, ephemeris data, and/or calculated trajectories of each satellite.

Connectivity graph 708 includes states 711, 712, 713, and 714. Satellites 706 of constellation 705 may operate in each of states 711, 712, 713, 714, and 715 for different durations of time 709 during a time interval shown in connectivity graph information 710 (e.g., between 21:14:00 and 21:32:50). By way of example, satellites 706 may be in state 711 for a first duration, state 712 for a second duration, state 713 for a third duration, state 714 for a fourth duration, and state 715 for a fifth duration as illustrated in the timewise view shown in display window 703. In some examples, states 711-715 may correspond to a subset of satellites 706 in constellation 705. In other examples, states 711-715 may correspond to all of satellites 706 in constellation 705.

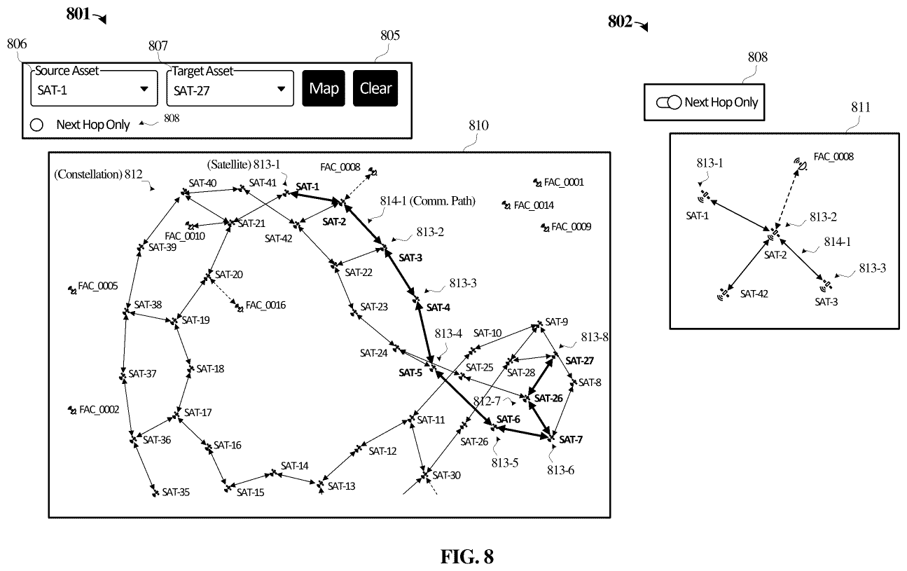

FIG. 8 illustrates exemplary aspects of a user interface (UI) used in an implementation. FIG. 8 includes aspect 801, which includes asset selection menu 805 and display window 810 of a UI, and aspect 802, which includes hop selector menu 808 and display window 811 of a UI. In various examples, the menus and display menus of aspects 801 and 802 may be included in a user interface (e.g., UI 601 of FIG. 6, UI 701 of FIG. 7) of a computing device or system, such as mission planning module 110 or command and control module 115 of FIG. 1.

Referring first to aspect 801, asset selection menu 805 represents a portion of a UI that a user can use to input and view a source asset 806 (e.g., a first satellite) and a target asset 807 (e.g., a last satellite) to be used in a communication network among a constellation 812 of satellites 813. As illustrated, a user may select “SAT-1” (satellite 813-1) as the source asset 806 and “SAT-27” (satellite 813-8) as the target asset 807 for a communication network. Asset selection menu 805 may also include a “map” function, a “clear” function, and a “next hop only” function (hop selector menu 808), each of which a user can click, tap, touch, or otherwise interact with to influence the content displayed on display window 810. For example, when a user clicks “map,” visual representations of communication paths 814 between specific satellites 813 of constellation 812 may be displayed in display window 810 (denoted by bolded lines in display window 810). When a user clicks “clear,” the visual representations of communication paths 814 may be reverted to a default or different setting.

It follows that display window 810 may display visual representations of constellation 812, satellites 813 of constellation 812, and communication paths 814 between individual ones of satellites 813. In this example, an orchestration system, such as MOC 120 of FIG. 1, may identify communication paths 814 between satellites 813-1 and 813-8 based on the selection of source asset 806 and target asset 807, among other requirements and information. Communication paths 814 may be displayed using bolded lines, colored lines, or by some other indication in display window 810.

Referring next to aspect 802, aspect 802 includes hop selector menu 808 of asset selection menu 805 and display window 811. Hop selector menu 808 may include a button, toggle switch, or other icon that a user can interact with to enable or disable a view of visual representations displayed in a display window of a UI. In this aspect, a user may enable functionality of hop selector menu 808 to show a “next hop” in a communication network established among satellites 813 of constellation 812 in display window 811. When “next hop” is enabled via hop selector menu 808, display window 811 may include visual representations of a portion of constellation 812 including a satellite following the source asset 806 along communication paths 814 (e.g., satellite 813-2). More specifically, display window 811 may include a visual representation of satellite 813-2, neighboring satellites relative to satellite 813-2, and communication paths between satellite 813-2 and the neighboring satellites.

In various other examples, a user may select a different combination of satellites 813 of constellation 812 for source asset 806 and target asset 807, which may cause an orchestration system to generate other communication paths and the UI to display different visual representations on display windows 810 and 811. Accordingly, as a user interacts with UI 801, the user can dynamically build a mesh communication network among constellation 812 based on inputs provided to UI 801.

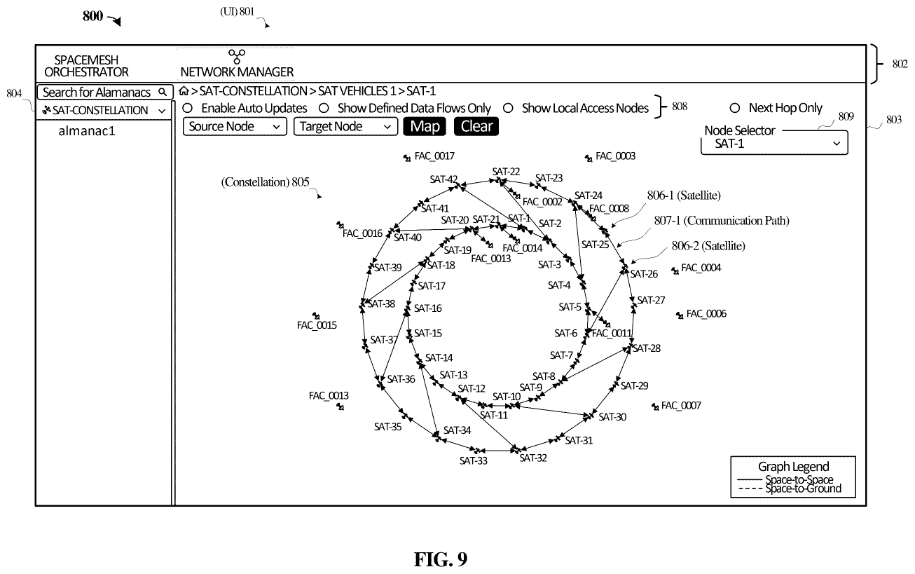

FIG. 9 illustrates exemplary aspects of a user interface used in an implementation. FIG. 9 includes UI 901, which includes function toolbar 902, display window 903, and almanac list 904. In various examples, UI 901 may be presented in a computing device or system, such as mission planning module 110 or command and control module 115 of FIG. 1.

In use, UI 901 can provide a visual representation of assets in a system, such as satellites 906 in constellation 905, and functions of an application presented through UI 901. Function toolbar 902 may include one or more icons representative of functions or views that can be navigated through by interacting with UI 901 (e.g., touch, click, tap, swipe). For example, function toolbar 902 may include an icon representative of a network manager function, among other functions and views. Upon interacting with an option of function toolbar 902, UI 901 may present a visual representation on display window 903.

In aspect 900, UI 901 shows an example visual representation of constellation 905 on display window 903 based on the network manager function of functional toolbar 902. Constellation 905 may include a number of satellites 906 arranged in concentric rings, although other arrangements may be contemplated. Almanac list 904 may include a list of almanacs (e.g., almanac), and each almanac listed and displayed in almanac list 904 may include mapping indications of constellation 905 and satellites 906 thereof, communication paths 907 between satellites 906, and metrics and information about satellites 906 and communication paths 907, such as applicable time windows for communication paths 907, indications of lines-of-sight between satellites 906, and router configuration parameters of satellites 906 to enable communication paths 907, among other information. Accordingly, for an almanac, a number of satellites of constellation 905 may communicate with one or more other neighboring satellites in constellation 905 for a time interval. The lines connecting each satellite in the visual representation shown in display window 903 may represent communication paths 907 between the satellites. For example, satellite 906-1 and satellite 906-2 may communicate with each other via communication path 907-1.

In various examples, a user may click, tap, touch, or otherwise interact with each satellite of constellation 905 to view information about the satellite, zoom in or zoom out on display window 903 to view communication paths 907 between satellites 906, and toggle between different hops or nodes (via node selector 909) of constellation 905, among other functions. For instance, a user may click on satellite 906-1 to view a state of satellite 906-1 at a given time. The state of a satellite may refer to an operation status, a current position, a current orientation, and scheduled maneuvers of the satellite, among other information. Additionally, a user may enable one or more options that provide different functionality via toggle buttons 908 displayed on display window 903. Toggle buttons 908 may include options related to enabling automatic updates of a selected almanac (e.g., router configuration updates), showing defined data flows only, and showing local access nodes within constellation 905. Other options may also be included in UI 901.

In some embodiments, display window 903 may further include a timewise view corresponding to the almanac selected from almanac list 904, which may indicate timing information about communication paths 907 over a time interval (e.g., connectivity graph 708). As such, a user may be able to view which communication paths may be valid for a given time during a time interval, for example, based on the almanac selection.

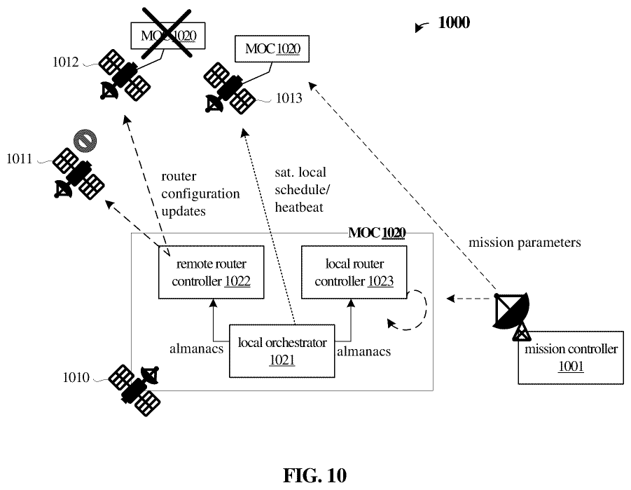

FIG. 10 illustrates techniques of establishing a communication network among satellites in a constellation in an implementation. FIG. 10 includes an operational scenario where a first mesh node (e.g., satellite, space vehicle) can perform mesh orchestration operations for itself as well as for one or more other nodes. This can represent a hybrid approach where the fully distributed example in FIG. 5 might include management of one mesh node by another mesh node.

System 1000 includes a constellation of satellites 1010-1013, as well as optional mission controller 1001, which may comprise a ground system which can receive and relay mission and data flow requests from various entities. Satellite 1010 and 1013 are shown as including instances of mesh orchestration controller (MOC) 1020. Satellite 1012 also might have an instance of MOC 1020, but this instance might be inoperable at the present time, including failure, attack mitigation/isolation, maintenance, degraded performance states, or other issues. Also, satellite 1011 is shown as lacking any MOC 1020 instance, such as for outdated hardware, failed hardware/software, or other components which cannot execute an instance of MOC 1020 but still allow for a local routing of network traffic and participation in a mesh network.

MOC 1020 can include local router controllers (1023) and remote router controllers (1022), as well as a local orchestrator (1021). In operation, local orchestrator 1021 operates according to any of the mesh orchestration controllers discussed herein, such as determining or receiving data flow requests, mission requests, determining local connectivity schedules, receiving connectivity schedules locally-determined by other nodes, merging connectivity schedules, determining forwarding almanacs by applying one or more selectable routing algorithms to the merged connectivity schedules, and applying the forwarding almanacs to configuration router operations.

However, in this example, the router operations can be determined for not only a local router of a local satellite instantiating MOC 1020, but also for other satellites which may have disabled MOC instances or non-existent MOC instances, such as for satellites 1011 and 1012. Local orchestrator 1021 can thus provide remote almanacs to remote router controller 1022 which can control operations of remote routers on other satellites, or can distribute routing configurations or router tables to other satellites. Local orchestrator 1021 can also provide local almanacs to local router controller 1023 which can control local routing of mesh traffic for satellite 1010.

Advantageously, the example in FIG. 10 can provide a modular capability to “remotely” command and configure mesh nodes that are either unable or unwilling to run the MOC 1020 software onboard. Instead of directly commanding/configuring onboard hardware, an instance of MOC 1020 could send “just in time” commands (via remote router controller 1022) to a ‘dependent’ satellite node. However, unlike centrally managed approaches, these instances of MOC 1020 could be located on the ground and/or distributed across other capable mesh nodes. These instances of MOC 1020 could even dynamically migrate over time or serve as backups to bolster overall system resiliency. A similar approach could also be applied to decentralized almanac generation to support satellites that cannot run the full MOC software suite on-board.

Thus, the examples herein can provide a method of operation that includes obtaining a request to generate a communication network for a time interval among a constellation of satellites, and identifying a local connectivity schedule covering at least the time interval for a satellite relative to other satellites of the constellation. The method also includes producing a merged connectivity schedule by merging the local connectivity schedule with additional local connectivity schedules determined by other satellites of the constellation. Based at least on applying a selected routing algorithm to the merged connectivity schedule, the method includes generating a forwarding almanac covering at least the time interval for the satellite, and establishing at least a portion of the communication network during the time interval by at least configuring a router of the satellite in accordance with the forwarding almanac.

The method of operation can include where the forwarding almanac comprises a route configuration for the router during the time interval. The method can include configuring the router of the satellite with the route configuration to form at least a portion of the communication network among the constellation for the time interval. The method can include where the forwarding almanac comprises route configurations for the router and for at least one router of another satellite of the constellation during the time interval. The method can include configuring the router of the satellite with a first portion of the route configurations, and distributing a second portion of the route configurations for configuring the router of the other satellite. The method can include where the request comprises a set of requirements for the communication network indicative of at least one among identities of preferred nodes to be included in the communication network, a bandwidth target, a latency target, a quality of service target, a selected routing algorithm, or a timeframe target that includes the time interval. The method can include where the selected routing algorithm comprises at least one among a lowest latency routing algorithm, a highest bandwidth routing algorithm, a shortest distance routing algorithm, a hop minimization algorithm, a Dijkstra's routing algorithm, or a mission specific routing algorithm. The method can include generating the local connectivity schedule by at least determining which satellites among the constellation have line-of-sight communication connectivity to the satellite during the time interval. The method can include receiving the additional local connectivity schedules from the other satellites in the constellation, and distributing the local connectivity schedules and the additional local connectivity schedules to one or more among the other satellites in the constellation.

FIG. 11 illustrates mesh orchestration control system 1100 and associated software 1105 in an implementation. FIG. 11 illustrates control system 1100 that is representative of any system or collection of systems in which the various operational architectures, scenarios, and processes disclosed herein may be implemented. For example, control system 1100 can be used to implement elements of satellites or MOC 120 instances of FIG. 1, MOC 300 of FIG. 3, satellites or MOC 520 instances of FIG. 5, satellites or MOC instances 1020 of FIG. 10, or any mesh node, space vehicle, orchestration system, router controller, satellite or other node discussed herein.

Control system 1100 may be implemented as a single apparatus, system, or device or may be implemented in a distributed manner as multiple apparatuses, systems, or devices. Control system 1100 includes, but is not limited to, processing system 1102, storage system 1103, software 1105, communication interface system 1107, and user interface system 1108. Processing system 1102 is operatively coupled with storage system 1103, communication interface system 1107, and user interface system 1108.

Processing system 1102 loads and executes software 1105 from storage system 1103. Software 1105 includes applications 1120, which are representative of the processes, services, and platforms discussed with respect to the included Figures. When executed by processing system 1102 to produce a set of parameters to configure routing of a communication route among a constellation of satellites to establish a communication network for a time interval indicated in a request, among other services, software 1105 directs processing system 1102 to operate as described herein for at least the various processes, operational scenarios, and sequences discussed in the foregoing implementations. Control system 1100 may optionally include additional devices, features, or functionality not discussed for purposes of brevity.

Referring still to FIG. 11, processing system 1102 may comprise a microprocessor and processing circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, application specific processors, and logic devices, as well as any other type of processing device, combinations, or variations thereof.

Storage system 1103 may comprise any computer readable storage media readable by processing system 1102 and capable of storing software 1105. Storage system 1103 may include volatile and nonvolatile, removable and non-removable media implemented in any method or technology for storage of information, such as computer readable instructions, data structures, program modules, or other data. Examples of storage media include random access memory, read only memory, magnetic storage, optical storage, flash memory, virtual memory and non-virtual memory, other storage devices, or any other suitable storage media. In no case is the computer readable storage media a propagated signal. In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 may be implemented in program instructions and among other functions may, when executed by processing system 1102, direct processing system 1102 to operate as described with respect to the various operational scenarios, sequences, and processes illustrated herein. For example, software 1105 may include program instructions comprising applications 1120, operating system 1121, and data 1122 that provide configuration of a communication network among a constellation of satellites, among other services. In particular, the program instructions may include various components or modules that cooperate or otherwise interact to carry out the various processes and operational scenarios described herein. The various components or modules may be implemented in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software or other application software, in addition to or that include applications 1120. Software 1105 may also comprise firmware or some other form of machine-readable processing instructions executable by processing system 1102.

Software 1105, when loaded into processing system 1102 and executed, may transform a suitable apparatus, system, or device (of which control system 1100 is representative) overall from a general-purpose computing system into a special-purpose computing system customized to provide mesh network orchestration and configuration of communication network and routing parameters, among other services. Indeed, encoding software 1105 on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary storage, as well as other factors. For example, if the computer-readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Applications 1120 can include communications control system 1130, flight control system 1135, and mesh orchestration system 1140. Communications control system 1130 includes communications protocol control interface 1131 and telemetry 1132. Flight control system 1135 includes trajectory control interface 1136, avionics control interface 1137, and telemetry 1138. Mesh orchestration system 1140 includes request interface 1141, connectivity coordination interface 1142, mesh orchestrator 1143, and route configuration interface 1144.

Turning first to communications control system 1130, communications protocol control interface 1131 can direct operation of onboard communications equipment (e.g., routers, switches, software-defined routers) based on router configuration parameters provided to communications protocol control interface 1131. Telemetry 1132 can be configured to collect and store instrumentation data for further transfer during operations of a satellite during orbit.

Turning next to flight control system 1135, trajectory control interface 1136 may be configured to determine one or more maneuvers and velocities to perform the one or more maneuvers of a satellite. Avionics control interface 1137 may be configured to enable operation of onboard instruments and equipment of a satellite during flight and in-orbit operations. Examples of the instruments and equipment may include sensors, gyroscopic/accelerometer, global positioning units, star trackers, and other elements. Telemetry 1138 can be configured to collect and store instrumentation data for further transfer during operations of a satellite during orbit.

Turning next to mesh orchestration system 1140, request interface 1141 may be configured to receive mission parameters and data flow requests from a central node, satellites, nodes, or a user/client indicating a request for a communication data flow between endpoints in a constellation of satellites. Request interface 1141 can also receive constellation information and data flow information along with the mission requests. Connectivity coordination interface 1142 may be configured to exchange or distribute heartbeat messaging and local connectivity schedules among mesh nodes.

Mesh orchestrator 1143 can provide various mesh network orchestration, control, assembly, planning, and router control features, such as those noted herein. For example, mesh orchestrator 1143 can obtain a mission request to generate a communication network for a time interval among a constellation of satellites, and identify one or more local connectivity schedules for satellites of the constellation based at least on a state of the satellites of the constellation during at least the time interval. Mesh orchestrator 1143 can produce merged connectivity schedules by at least merging a local connectivity schedule with one or more additional local connectivity schedules determined by one or more other satellites of a constellation. Mesh orchestrator 1143 can also apply a selected routing algorithm against merged connectivity schedules to generate a communication route for the satellite of the constellation a time interval, and apply a communication route in a router element to form a mesh network which varies over time in connectivity among nodes.

Route configuration interface 1144 may be configured to create or implement routing configurations and routing tables with respect to router equipment, which may be included in communication interface system 1107. The routing configurations or tables can include parameters for establishing communication pathways and routes among mesh nodes, such as among satellites in a constellation. Route configuration interface 1144 may further be configured to utilize routing tables to create a universal, router-agnostic routing table, and further convert the universal routing table to specific formats utilized by routers and other communication elements onboard satellites implicated by the request. Router configuration interface 1144 can also distribute routing configurations and routing tables to other mesh nodes which may be at least partially controlled by a first mesh node.

Data 1122 may include various information related to one or more mesh nodes, including satellites in a constellation, and communication network parameters for configuring communication pathways therewith. Data 1122 includes ephemeris 1145, almanacs 1146, connectivity schedules 1147, and satellite statuses 1148. Ephemeris 1145 may include ephemeris data related to each satellite in a constellation, including current positions and orientations and projected trajectories, as well as current and projected neighbor node information and parameters. Almanacs 1146 may include sets of time-scheduled routing parameters (e.g., forwarding almanacs) for configuring communication networks among satellites in a constellation. Connectivity schedules 1147 may include local or merged schedules associated with current or projected satellite connections among a constellation within various timeframes (e.g., connectivity graphs), visualized graph-based data structures, metrics and parameters associated with communication routes, pathways, and hop points, and the like. Satellite statuses 1148 may include heartbeat state and active/inactive status information of satellites in a constellation corresponding to operational status, instrumentation status, and the like.

Communication interface system 1107 may include communication connections and devices that allow for communication with other computing systems or electrical components (not shown) over communication links or communication networks (not shown). Examples of connections and devices that together allow for inter-system communication may include transceivers, network interface controllers, antennas, power amplifiers, RF circuitry, and other communication circuitry. The connections and devices may communicate over communication media to exchange communications with other computing systems or networks of systems, such as metal, glass, air, or any other suitable communication media. Physical or logical elements of communication interface system 1107 can provide constellation information, satellite router information, and other information.

Communication interface system 1107 may include various hardware and software elements for interfacing with satellite instrumentation, avionics, sensors, networking devices, and other devices. For example, communication interface system 1107 can receive or obtain global position, orbital position, gyroscope and/or accelerometer data, instrumentation collection data, and the like.

Communication between communication control system 1100 and other elements or systems (not shown), may occur over communication links or communication networks and in accordance with various communication protocols, combinations of protocols, or variations thereof. For example, communication control system 1100 when implementing a mesh orchestration/control device, might communicate with communication/processing elements over corresponding digital communication links comprising Ethernet interfaces, serial interfaces, serial peripheral interface (SPI) links, inter-integrated circuit (I2C) interfaces, universal serial bus (USB) interfaces, UART interfaces, or wireless interfaces. When network links are employed, example networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some network communication protocols that may be used include, but are not limited to, the Ethernet, Internet protocol (IP, IPv4, IPv6, etc., . . . ), the transmission control protocol (TCP), and the user datagram protocol (UDP), as well as any other suitable communication protocol, variation, or combination thereof.

User interface system 1108 may include a software or virtual interface such as a terminal interface, command line interface, or application programming interface (API). User interface system 1108 may also include physical user interfaces, such as keyboard, a mouse, a voice input device, or a touchscreen input device for receiving input from a user, such as during manufacturing testing or maintenance activities. User interface system 1108 may include telemetry interfaces, ephemeris interfaces, user command controls, router operation mode command controls, and user interface indications, visualizations, and representations, among others. Output devices such as displays, web interfaces, terminal interfaces, and other types of output devices may also be included in user interface system 1108. User interface system 1108 can provide output and receive input over a network interface, such as communication interface system 1107. In network examples, user interface system 1108 might packetize data for receipt by a display system or computing system coupled over one or more network interfaces. User interface system 1108 may comprise API elements for interfacing with users, other data systems, other user devices, web interfaces, and the like. User interface system 1108 may also include associated user interface software executable by processing system 1102 in support of the various user input and output devices discussed above. Separately or in conjunction with each other and other hardware and software elements, the user interface software and user interface devices may support a console user interface, graphical user interface, a natural user interface, or any other type of user interface.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

What is claimed is:

1. A method, comprising:
identifying a local connectivity schedule covering at least a time interval for a satellite relative to other satellites of a constellation of satellites;
producing a merged connectivity schedule by merging the local connectivity schedule with additional local connectivity schedules determined by other satellites of the constellation;
based at least on applying a selected routing algorithm to the merged connectivity schedule, generating a forwarding almanac covering at least the time interval for the satellite;
establishing at least a portion of a communication network during the time interval by at least configuring a router of the satellite in accordance with the forwarding almanac.

2. The method of claim 1, wherein the forwarding almanac comprises a route configuration for the router during the time interval; and comprising:
configuring the router of the satellite with the route configuration to form at least a portion of the communication network among the constellation for the time interval.

3. The method of claim 1, wherein the forwarding almanac comprises route configurations for the router and for at least one router of another satellite of the constellation during the time interval; and comprising:
configuring the router of the satellite with a first portion of the route configurations; and
distributing a second portion of the route configurations for configuring the router of the other satellite.

4. The method of claim 1, comprising:
processing a set of requirements to form the communication network indicative of at least one among identities of preferred nodes to be included in the communication network, a bandwidth target, a latency target, a quality of service target, a routing algorithm selection, or a timeframe target that includes the time interval.

5. The method of claim 1, wherein the selected routing algorithm is selected to implement routing configurations for instances of communication networks among at least one among a lowest latency routing algorithm, a highest bandwidth routing algorithm, a shortest distance routing algorithm, a hop minimization algorithm, a Dijkstra's routing algorithm, or a mission specific routing algorithm.

6. The method of claim 1, comprising:
generating the local connectivity schedule by at least determining which satellites among the constellation have line-of-sight communication connectivity to the satellite during the time interval.

7. The method of claim 1, comprising:
receiving the additional local connectivity schedules from the other satellites in the constellation; and
distributing the local connectivity schedules and the additional local connectivity schedules to one or more among the other satellites in the constellation.

8. A satellite, comprising:
an interface module comprising a router; and
a mesh orchestration module configured to:
obtain mission parameters for a communication network among a constellation of satellites;
based at least in part on the mission parameters, identify a local connectivity schedule covering at least a time interval for the satellite relative to other satellites of the constellation;
produce a merged connectivity schedule by merging the local connectivity schedule with additional local connectivity schedules determined by other satellites of the constellation;
based at least on applying a selected routing algorithm to the merged connectivity schedule, generate a forwarding almanac covering at least the time interval for the satellite;
establish at least a portion of the communication network during the time interval by at least configuring the router of the satellite in accordance with the forwarding almanac.

9. The satellite of claim 8, wherein the forwarding almanac comprises a route configuration for the router during the time interval; and comprising:
the mesh orchestration module configured to configure the router of the satellite with the route configuration to form at least a portion of the communication network among the constellation for the time interval.

10. The satellite of claim 8, wherein the forwarding almanac comprises route configurations for the router and for at least one router of another satellite of the constellation during the time interval; and comprising:
the mesh orchestration module configured to configure the router of the satellite with a first portion of the route configurations; and
the mesh orchestration module configured to distribute a second portion of the route configurations for configuring the router of the other satellite.

11. The satellite of claim 8, wherein the mission parameters comprises a set of requirements for the communication network indicative of at least one among identities of preferred nodes to be included in the communication network, a bandwidth target, a latency target, a quality of service target, a routing algorithm selection, or a timeframe target that includes the time interval.

12. The satellite of claim 8, wherein the selected routing algorithm comprises at least one among a lowest latency routing algorithm, a highest bandwidth routing algorithm, a shortest distance routing algorithm, a hop minimization algorithm, a Dijkstra's routing algorithm, or a mission specific routing algorithm.

13. The satellite of claim 8, comprising:
the mesh orchestration module configured to generate the local connectivity schedule by at least determining which satellites among the constellation have line-of-sight communication connectivity to the satellite during the time interval.

14. The satellite of claim 8, comprising:
the mesh orchestration module configured to receive the additional local connectivity schedules from the other satellites in the constellation; and
the mesh orchestration module configured to distribute, using the interface module, the local connectivity schedules and the additional local connectivity schedules to one or more among the other satellites in the constellation.

15. An apparatus, comprising:
one or more computer-readable storage media; and
program instructions stored on the one or more computer-readable storage media executable by a processing device to direct the processing device to at least:
obtain mission parameters for a communication network among a constellation of satellites;
based at least on the mission parameters, identify a local connectivity schedule covering at least a time interval for a satellite relative to other satellites of the constellation;
produce a merged connectivity schedule by merging the local connectivity schedule with additional local connectivity schedules determined by other satellites of the constellation;
based at least on applying a selected routing algorithm to the merged connectivity schedule, generate a forwarding almanac covering at least the time interval for the satellite;
establish at least a portion of the communication network during the time interval by at least configuring a router of the satellite in accordance with the forwarding almanac.

16. The apparatus of claim 15, wherein the forwarding almanac comprises a route configuration for the router during the time interval; and comprising further program instructions that direct the processing device to at least:
configure the router of the satellite with the route configuration to form at least a portion of the communication network among the constellation for the time interval.

17. The apparatus of claim 15, wherein the mission parameters comprises a set of requirements for the communication network indicative of at least one among identities of preferred nodes to be included in the communication network, a bandwidth target, a latency target, a quality of service target, a routing algorithm selection, or a timeframe target that includes the time interval.

18. The apparatus of claim 15, wherein the selected routing algorithm comprises at least one among a lowest latency routing algorithm, a highest bandwidth routing algorithm, a shortest distance routing algorithm, a hop minimization algorithm, a Dijkstra's routing algorithm, or a mission specific routing algorithm.

19. The apparatus of claim 15, comprising further program instructions that direct the processing device to at least:
generate the local connectivity schedule by at least determining which satellites among the constellation have line-of-sight communication connectivity to the satellite during the time interval.

20. The apparatus of claim 15, comprising further program instructions that direct the processing device to at least:
receive the additional local connectivity schedules from the other satellites in the constellation; and
distribute the local connectivity schedules and the additional local connectivity schedules to one or more among the other satellites in the constellation.
